(19) United States
(12) Patent Application Publication
(10) Pub. No.: US 2006/0000041 A1
(43) Pub. Date: Jan. 5, 2006

(54) Cleaning implement and joint therefor

(76) Inventors: Alen David Streutker, Florence, KY (US); Gary Ray Drake, Hamilton, OH (US); Gary Lee Loney, Hamilton, OH (US); Michael Stephen Maile, Maineville, OH (US); Mark Leslie Kacher, Mason, OH (US); Glenn Allen Bradbury, Mason, OH (US); Leonard Lik-Hang Tse, West Chester, OH (US); Gregory Spooner, Hong Kong (CN); Hoss Vong, Hong Kong (CN)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/119,180

(22) Filed: Apr. 29, 2005

Related U.S. Application Data
(62) Division of application No. 10/172,619, filed on Jun. 14, 2002.
(60) Provisional application No. 60/300,765, filed on Jun. 25, 2001.
(60) Provisional application No. 60/370,871, filed on Apr. 8, 2002.

(51) Int. Cl. B25G 3/38; A47L 13/20

(52) U.S. Cl. 15/144.1; 15/144.2

(57) ABSTRACT

A cleaning implement for removing debris from a surface comprises a handle, a mop head, and a joint connecting the handle and mop head; wherein the joint is adjustable and lockable. The joint allows the angle between the mop head and the handle to be adjusted appropriately and then locked into place. Another embodiment of the present cleaning implement comprises a handle and a mop head, wherein the mop heads comprises one or more gliders to facilitate the ability of the cleaning implement to glide smoothly across the surface being cleaned. Methods of removing debris comprise the step of contacting the surface with a cleaning implement of the present invention.

### CROSS REFERENCE TO RELATED APPLICATIONS

This application is a divisional application of U.S. application Ser. No. 10/172,619, filed Jun. 14, 2002, which claims the benefit of U.S. Provisional Application Ser. No. 60/300,765, filed Jun. 25, 2001, and U.S. Provisional Application Ser. No. 60/370,871, filed Apr. 8, 2002.

### TECHNICAL FIELD

The present invention relates to a cleaning implement optionally comprising a disposable cleaning sheet removably attached thereto for removing debris, such as human hair, pet hair, dirt, dust, and the like, from soft surfaces, such as carpeting, upholstery, and the like.

### BACKGROUND OF THE INVENTION

It is often difficult to remove unwanted debris from surfaces, especially from soft surfaces. For example, it is difficult to remove pet hair from carpeting. Conventional vacuum cleaners often do not do a sufficient job in removing pet hair from carpeting. Even though vacuum cleaners are capable of removing some pet hair from carpeting, it can be inconvenient to repeatedly use a vacuum cleaner because of its weight and power requirements. In addition, pet hair can become entangled in the roller brush of the vacuum cleaner requiring either cleaning or repair of the vacuum.

A number of devices have been disclosed to address the problem of removing debris from soft surfaces. For example, U.S. Pat. No. 4,703,538 issued to Silverstrone discloses a cleaning tool suited for picking up dirt, lint, and the like from rugs, floors, upholstered furniture and other surfaces. The cleaning tool of Silverstrone consists of an elongated handle having a pair of legs extending outwardly to engage a cylindrically shaped cleaning element having an external surface made of Velcro. Discs are fitted between the ends of the cylinder and the legs of the handle to fixedly mount the cylinder to the legs of the handle. The cleaning tool can then be pushed over the surface to be cleaned to pick up dirt, lint, and the like. However, this cleaning tool is inconvenient in that the consumer must manually clean the cylinder cleaning element after the cleaning element accumulates dirt, lint, and the like. Since the cylinder is fixedly mounted to the legs of the handle, the cleaning tool must be manually cleaned every time debris accumulates in the Velcro. Furthermore, the cleaning tool of Silverstrone does not provide the consumer any ability to adjust the angle between the legs of the handle and the handle, to allow a consumer to reach hard-to-reach places. In addition, the cleaning tool of Silverstrone can be difficult to push and pull across some surfaces, such as carpet, because the cylinder with an exterior surface of Velcro will tend to catch on carpeted surfaces.

A tool for removing animal hair from carpeting is disclosed in U.S. Pat. No. 4,042,995 issued to Varon. The tool of Varon contains a field of smooth tapered polyethylene bristles extending down from a head attached to a broom handle. The density of the bristles at the trailing edge is greater than elsewhere and the bristles are arranged in a saw-tooth leading edge pattern. As the tool is pulled through carpeting, the bristles pick up animal hair. The bristles are permanently attached to the head of the broom handle. As with the cleaning tool of Silverstrone, the tool of Varon suffers from the problem of having to manually clean out the bristles of the tool every time the bristles accumulate debris. Also, Varon does not provide any ability to adjust the angle between the head of the broom handle and the broom handle.

It has thus been desired to create a cleaning implement that can be conveniently used with removably attachable cleaning sheets that can remove debris, such as pet hair, from surfaces, such as soft surfaces, which can be conveniently disposed by the consumer after use. As a result, the cleaning sheet does not have to be manually cleaned out after each use, but instead is easily disposed of after use. It is further desired to provide such a cleaning implement that can be adjusted to reach hard-to-reach places and that glides easily across difficult surfaces to clean, such as carpet.

### SUMMARY OF THE INVENTION

The present invention relates to a cleaning implement for removing debris from a surface, especially soft surfaces such as carpet, preferably being used with a removably attachable cleaning sheet. The cleaning implement of the present invention generally comprises a handle and a mop head, wherein the handle and mop head are connected via a joint. The joint herein is preferably a lockable joint that can be unlocked such that the angle between the mop head and the handle can be adjusted to the desired angle, and then locked into the desired position.

The present invention further relates to a cleaning implement comprising a mop head connected to a handle, wherein the mop head comprises one or more gliders to facilitate the movement of the cleaning implement across relatively high-friction surfaces, such as carpet.

The present invention further relates to methods of using the cleaning implements of the present invention.

All documents cited herein are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### BRIEF DESCRIPTION OF THE DRAWINGS

FIG. 1 is a perspective view of a cleaning implement of the present invention comprising a lockable ratchet-type joint between a mop head and a handle of the cleaning implement.

FIG. 2 is a bottom view of the mop head of the cleaning implement of FIG. 1.

FIG. 3 is a side view of the mop head of the cleaning implement of FIG. 1.

FIG. 4 is a perspective view of a cleaning implement of the present invention comprising a uni-directional, lockable joint between a mop head and a handle of the cleaning implement.

FIG. 5 is an exploded view of the mop head of the cleaning implement of FIG. 4.

FIG. 6 is a perspective view of a cleaning implement of the present invention comprising a lockable ball-and-socket joint between a mop head and a handle of the cleaning implement.

FIG. 7 is a perspective view of a cleaning implement of the present invention comprising a uni-directional, lockable spring-loaded ball-bearing joint between a mop head and a handle of the cleaning implement.

FIG. 8 is a perspective view of the cleaning implement of FIG. 4 with a removable cleaning sheet attached thereto;

FIG. 9 is a perspective view of the cleaning implement of the present invention comprising a female locking member attached thereto;

FIG. 10 is a cross section view along the A-A axis of FIG. 12 of a female locking member;

FIG. 11 is a cross section view along the B-B axis of FIG. 12 of a female locking member;

FIG. 12 is a top view of the female locking member of FIG. 9;

FIG. 13 is a perspective view of a male locking member of the present invention;

FIG. 14 is a perspective view of a mop head and handle assembly where the handle is flexibly attached to the mop head;

FIG. 15 is an exploded view of a floor mop comprising a slideable locking member according to the present invention;

FIG. 16 is a perspective view of a floor mop of FIG. 15 in an unlocked position;

FIG. 17 is a perspective view of a floor mop of FIG. 15 in a locked position;

FIG. 18 is a side view of a floor mop of FIG. 16;

FIG. 19 is a side view of a floor mop of FIG. 17 being locked at a fixed angle;

FIG. 20 is a side view of a floor mop of FIG. 17 being locked at a fixed angle;

FIG. 21 is a perspective view of a floor mop comprising an extension being in an unlocked position;

FIG. 22 is a side view of a floor mop of FIG. 22;

FIG. 23 is a perspective view of a floor mop comprising a slideable locking member in an unlocked position according to the present invention;

FIG. 24 is a perspective view of the floor mop of FIG. 23 comprising a slideable locking member in a locked position;

FIG. 25 is a perspective view of a floor mop comprising a slideable locking member in a locked position according to the present invention;

FIG. 26 is a perspective view of a slideable collar member according to the present invention;

FIG. 27 is a perspective view of a floor mop comprising a slideable collar member according to the present invention;

FIG. 28 is a perspective view of the floor mop of FIG. 27 being in a locked position.

FIG. 29 is a side view of the floor mop of FIG. 27;

FIG. 30 is a side view of the floor mop of FIG. 28;

FIG. 31 is a side view of the floor mop of FIG. 28 being locked at a different angle;

FIG. 32 is a perspective view of a slideable collar member according to the present invention;

FIG. 33 is a perspective view of a floor mop comprising a slideable collar member according to the present invention;

FIG. 34 is a perspective view of the floor mop of FIG. 33 being in a locked position;

FIG. 35 is a perspective view of a locking member according to the present invention;

FIG. 36 is a side view of a floor mop comprising the locking member of FIG. 35 and being in a locked position;

FIG. 37 is a perspective view of a locking member according to the present invention;

FIG. 38 is a cross section side view of a floor mop comprising the locking member of FIG. 37 and being in a locked position;

FIG. 39 is a front view of a mop head comprising gliding members in an upward position according to the present invention;

FIG. 40 is a front view of a mop head comprising gliding members in a downward position according to the present invention;

FIG. 41 is a perspective view of a mop head of FIG. 40 comprising gliding members in an upward position according to the present invention;

FIG. 42 is a front view of a mop head comprising gliding members in a downward position according to the present invention;

FIG. 43 is a side view of a mop head comprising the gliding members of FIG. 42 in an upward position;

FIG. 44 is a front view of a mop head comprising gliding members in a downward position according to the present invention;

FIG. 45 is a front view of a mop head comprising the gliding members of FIG. 44 in a downward position;

FIG. 46 is a perspective view of FIG. 45 comprising the gliding members in a downward position;

FIG. 47 is a perspective view of a gliding member of FIG. 44;

FIG. 48 is a front cross-section view of a mop head comprising retractable gliding members in a downward position according to the present invention;

FIG. 49 is a front cross-section view of FIG. 48 comprising the gliding members in an upward position;

FIG. 50 is a top view of the retractable gliding members mechanism of FIG. 48 where the mop head housing is not shown for clarity;

FIG. 51 is a left side view of the retractable gliding members mechanism of FIG. 50;

FIG. 52 is a perspective view of a floor mop comprising a frame member and a cleaning sheet having protrusions according to the present invention;

FIG. 53 is a side view of the floor mop of FIG. 52 where the handle is not being shown for clarity;

FIG. 54 is a side view of the floor mop according to the present invention where the frame member is in an upward position;

FIG. 55 is a perspective view of the mop head of FIG. 52;

FIG. 56 is a perspective view of the mop head of FIG. 54.

### DETAILED DESCRIPTION OF THE INVENTION

The cleaning implements of the present invention generally comprise a handle connected to a mop head via a joint. The cleaning implement can be used to hold a removably attachable cleaning sheet and the cleaning implement used to remove debris from surfaces.

I. Removable Cleaning Sheets

A variety of removable cleaning sheets can be attached to the cleaning implement herein to remove debris from surfaces. The removable cleaning sheets useful in with the present cleaning implements comprise a wide variety of different types of substrates. The substrates can be woven or nonwoven and can be made of synthetic, natural, or hybrid fibers. The substrates can also be a polymeric film. The substrates can be made from a variety of processes including, but not limited to, hydroentanged, spunbonded, meltblown, carded, and the like. Preferably the substrates are nonwoven and made of synthetic fibers from a hydroentangling or spunbonded process.

Suitable removable cleaning sheets for use with the cleaning implements of the present invention include those described in co-pending U.S. application Ser. No. 09/082,349 filed May 20, 1998; Ser. No. 09/082,396 filed May 20, 1998; and Ser. No. 09/729,626 filed Nov. 30, 2000. Other suitable cleaning sheets are described in U.S. Pat. Nos. 5,525,397 and 6,143,393.

Preferred removable cleaning sheets for use with the cleaning implements of the present invention include disposable cleaning sheets comprising a substrate and a plurality of protrusions affixed to the substrate. The protrusions can include, for example, hook-shaped protrusions, slanted fibers, bristles, and the like. Such cleaning sheets are particularly suitable for removing debris, such as hair, from soft surfaces, such as upholstery, fabric, carpet, and the like. These preferred cleaning sheets are described in detail in co-pending U.S. Application Ser. No. 60/300,700 filed Jun. 25, 2001 by Kacher et al. (P&G Case 8604P), U.S. Application Ser. No. 60/300,760 filed Jun. 25, 2001 by Kacher et al. (P&G Case 8605P), U.S. Application Ser. No. 60/370,712 filed Apr. 8, 2002 by Kacher et al. (P&G Case 8604P2), and U.S. Application Ser. No. 60/370,715 filed Apr. 8, 2002 by Kacher et al. (P&G Case 8605P2).

II. Cleaning Implements

The cleaning implements of the present invention are preferably used to clean household surfaces, especially soft surface such as upholstery, fabric, carpet, and the like. It is often difficult, however, to remove debris from such soft surfaces with a cleaning implement, because the cleaning implement tends to “catch” or “snag” on the soft surface as it moves across the surface. This particularly can be a problem if one is attaching to the cleaning implement cleaning sheets comprising a substrate and a plurality of protrusions affixed to the substrate, such as those incorporated by reference hereinbefore. This can actually result in a couple different problems. A first problem results if the mop head of the cleaning implement is pivotably connected to the handle of the cleaning implement via a pivotable joint, the mop head will become unstable as the cleaning implement moves across the surface and the mop head will twist undesirably, making it difficult to remove any debris from the surface. A second problem is that it is difficult for a consumer to move the cleaning implement across the surface, because of the relatively high-friction generated between the surface being cleaned and the cleaning implement.

To solve these problems, the cleaning implements of the present invention can incorporate two distinct aspects, each of which can be included in the cleaning implement by itself, or can be incorporated in combination with the other aspect.

A. Lockable Joint

A first preferred aspect of the present cleaning implements is an adjustable, lockable joint that connects the mop head to the handle of the cleaning implement. The joint is adjustable in the sense that the consumer can adjust the angle between the mop head and the handle of the cleaning implement to make it more convenient to reach hard-to-reach places or to bring the handle to a more comfortable position for mopping, in accordance with the height of the consumer. The joint is lockable in the sense that once the consumer adjusts the implement to the desired angle between the mop head and the handle, the consumer can then maintain the desired angle between the mop head and the handle by locking the joint connecting the mop head and handle.

A lockable joint can be important for a couple of reasons. First, a lockable joint will prevent the mop head from twisting or becoming unstable as the cleaning implement is moved across the surface being cleaned. Second, a lockable joint can provide the consumer with additional leverage when moving the cleaning implement across the surface being cleaned. This is particularly important when the cleaning implement is being used with disposable cleaning sheets comprising a substrate and a plurality of protrusions affixed to the substrate, as incorporated by reference hereinbefore.

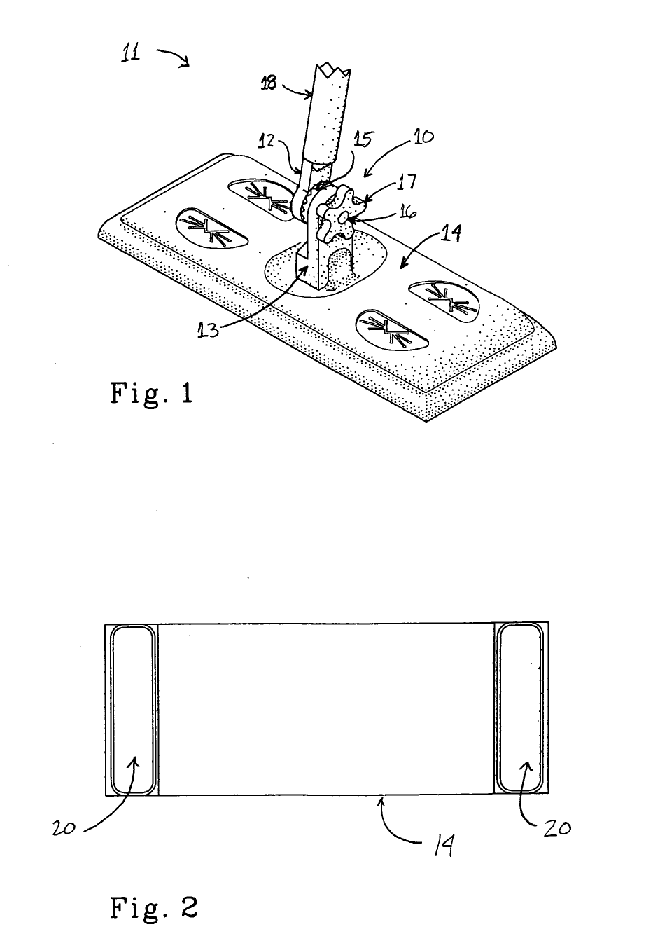

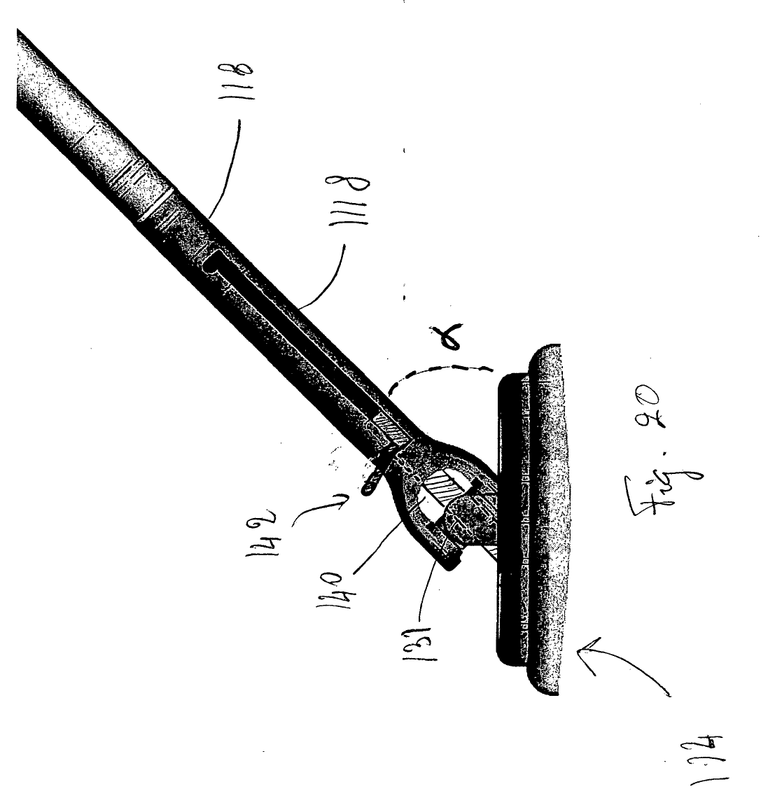

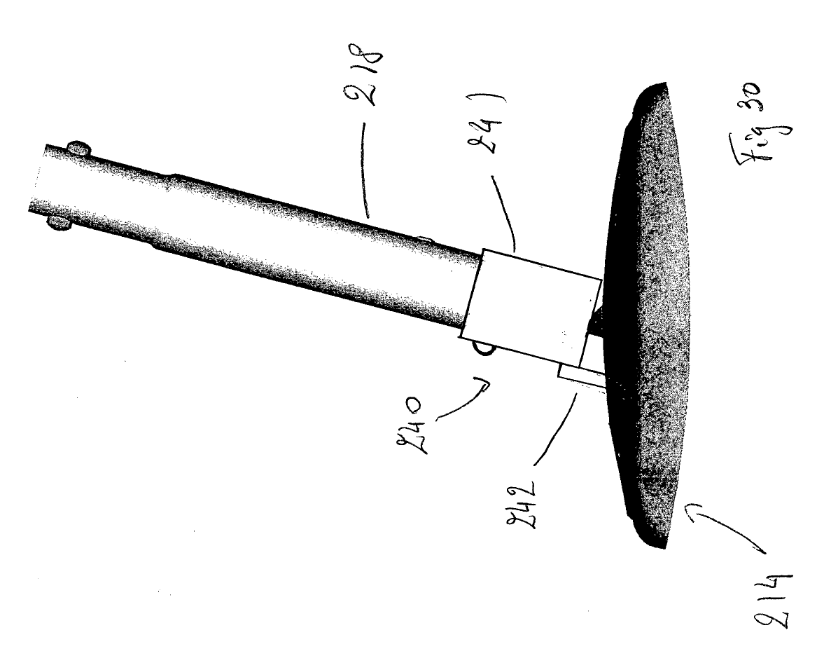

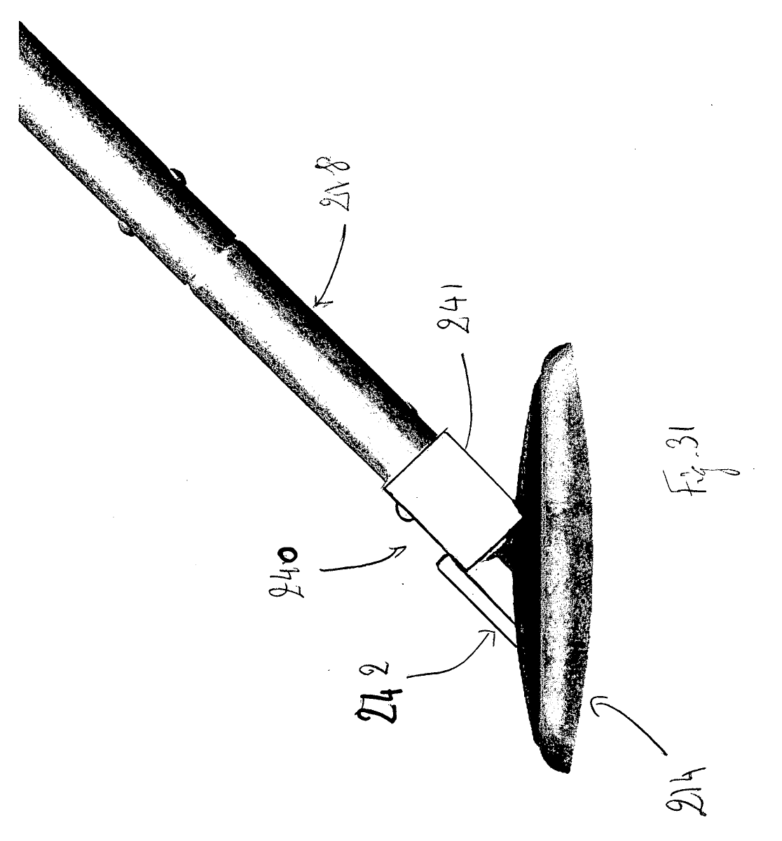

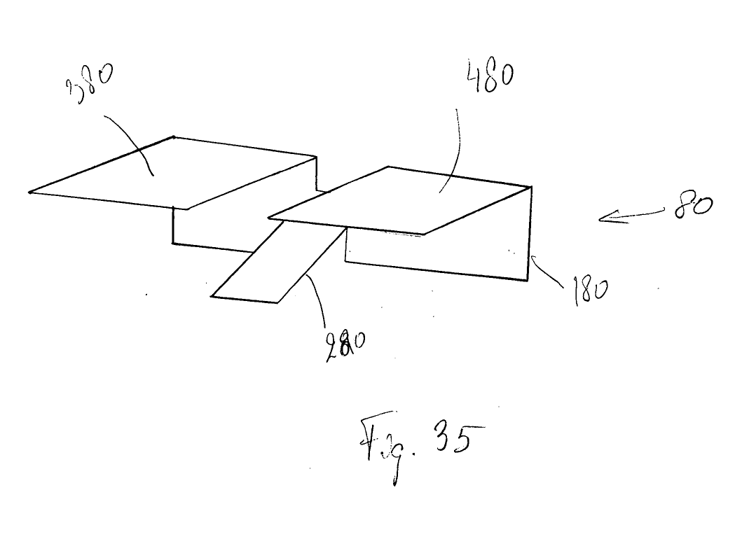

A variety of different joints can be incorporated in the present cleaning implements for connecting the mop head to the handle of the cleaning implement. Non-limiting examples of suitable joints for the present cleaning implements are illustrated in FIGS. 1, 4, 6-38.

FIG. 1 illustrates a suitable joint 10 for a cleaning implement 11 of the present invention. This joint 10 is both adjustable and lockable. The joint 10 is comprised of a handle portion 12 and a base portion 13. The handle portion 12 is connected to a handle 18 of the cleaning implement 11. The base portion 13 is connected to a mop head 14 of the cleaning implement 11. The handle portion 12 and the base portion 13 each comprise a plurality of engaging teeth 15. Both the handle portion 12 and the base portion 13 have holes therethrough to facilitate insertion of a bolt 16 and a nut 17 to join the handle portion 12 and the base portion 13 together to form the joint 10. The plurality of engaging teeth 15 of the handle portion 12 and of the base portion 13 engage one another such that the joint 10 does not move when the nut 17 and bolt 16 are tightened. When the nut 17 and bolt 16 are tightened, the mop head 14 and the handle 18 of the cleaning implement 11 are at a fixed angle relative to one another. The joint 10 is therefore in a locked position. The nut 17 and bolt 16 can then be loosened, such that the engaging teeth 15 of the handle portion 12 and the base portion 13 no longer engage one another, which allows the joint 10 to rotate 180° about the bolt 16. The user can thus adjust the angle between the mop head 14 and the handle 18. Once the desired angle is obtained, the user can re-tighten the nut 17 and bolt 16, causing the engaging teeth 15 of the handle portion 13 and the base portion 13 to engage each other, thereby locking the joint 10 into the desired position.

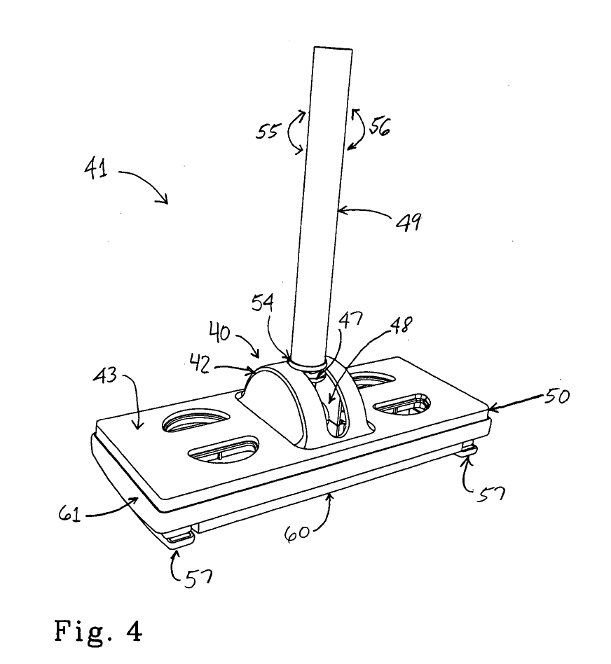

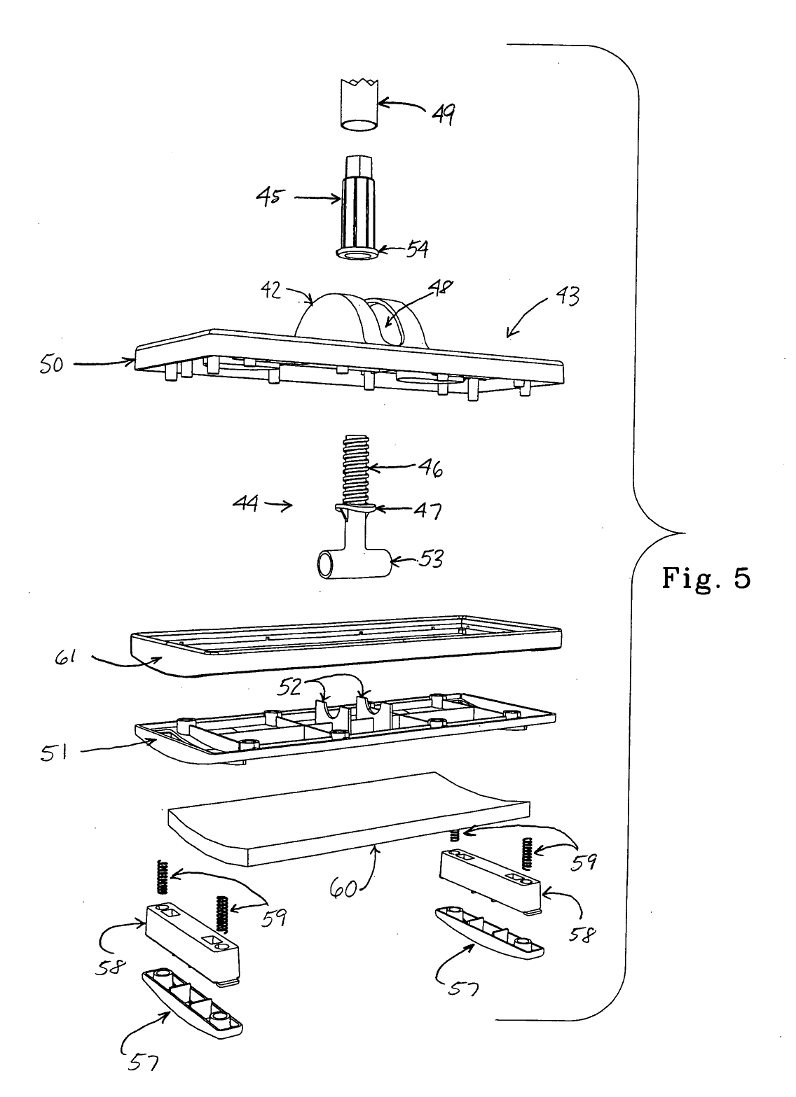

FIGS. 4 and 5 illustrate another suitable joint 40 for a cleaning implement 41 of the present invention. The joint 40 comprises a base portion 42 (which can be molded as part of an upper base 50 of a mop head 43), a stem 44, and a threaded plug 45. The stem 44 comprises a threaded portion 46, a first articulating surface 47, and a stem base 53. The base portion 42 comprises a slot 48 through which the threaded portion 46 of the stem 44 can extend. The threaded portion 46 of the stem 44 engages the threaded plug 45. The threaded plug 45 connects to a handle 49 of the cleaning implement 41 and comprises a second articulating surface 54. The mop head 43 comprises an upper base 50 and a lower base 51. The lower base 51 has a pair of ribs 52 within which the stem base 53 can rotate.

The joint 40 of FIGS. 4 and 5 can be locked and unlocked by twisting the handle 49 in a counterclockwise 55 or clockwise 56 direction, depending on the threaded portion 46 of the stem 44. As the handle 49 is being twisted so as to lock the joint 40, the first articulating surface 47 and the second articulating surface 54 are drawn closer together. As they are drawn closer together, the first articulating surface 47 engages the interior surface of the base portion 42, while the second articulating surface 54 engages the outer surface of the base portion 42. The friction between the first and second articulating surfaces 47, 54 and the base portion 42 becomes great enough so as to effectively lock the joint 40 into a position. The angle between the handle 49 and the mop head 43 is thus locked into position. The joint 40 can then be unlocked by twisting the handle 49 in the opposite counterclockwise 55 or clockwise 56 direction, thereby moving the first and second articulating surfaces 47, 54 away from each other. The handle 49 is then free to move along the slot 48 of the base portion 42. Once the user obtains the desired angle between the handle 49 and the mop head 43, the user can lock the joint 40 again by twisting the handle 49.

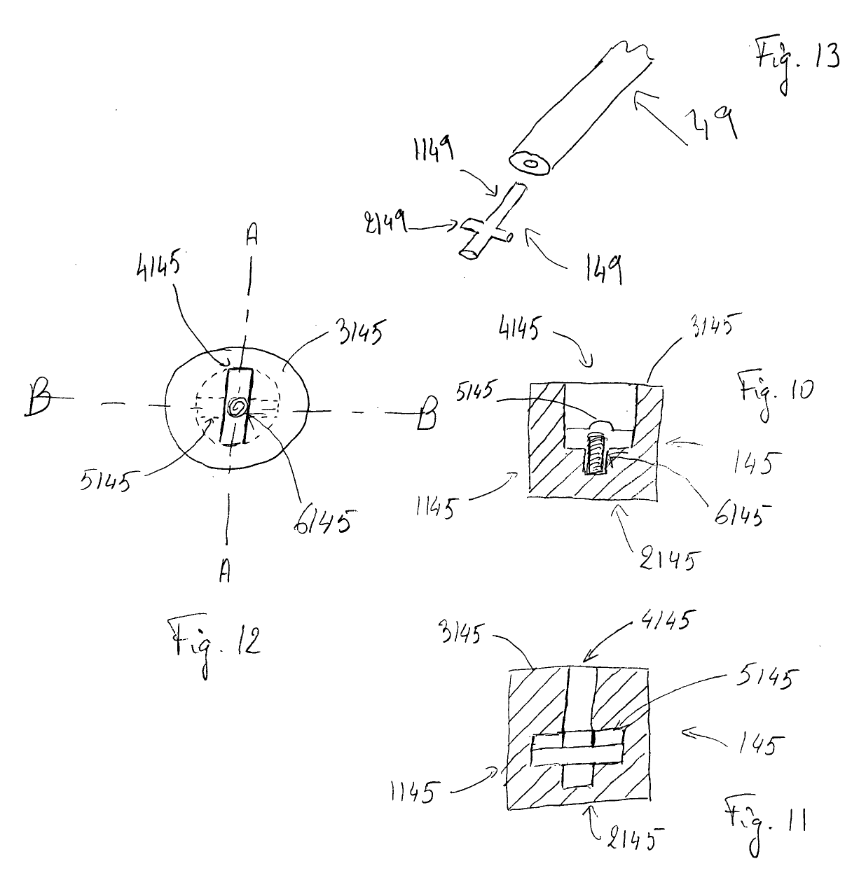

In another embodiment represented in FIGS. 9-14, the threaded plug 45 and the handle 49 can be removably attached by using a female member 145 attached to the threaded plug 45 and a male member 149 attached to the bottom portion of the handle 49. The female member 145 comprises a body defined by a substantially cylindrical wall 1145 and is closed at one end by a bottom portion 2145 as represented in FIG. 10-12. This bottom portion 2145 can be attached to the threaded plug 45. The female member 145 also comprises a keyed plate member 3145 having a substantially disc shape which is attached to the body of the female member 145, preferably to the inner surface of the cylindrical wall 1145 such that a hollow space between the bottom portion 2145 and the keyed plate member 3145 is created. The keyed plate member 3145 has a top and a bottom surface and comprises an opening 4145 which can be a slit or cut out through the keyed plate member 3145. This opening preferably starts from the top surface and ends at the bottom surface of the keyed plate member 3145. The bottom surface of the keyed plate member 3145 can also comprise a groove or a notch 5145 which is at an angle greater than 0 degrees relative to the opening 4145. In a preferred embodiment, the groove 5145 is substantially perpendicular to the opening 4145. Optionally but preferably, the female member 145 comprises a spring member 6145, preferably located within the cylindrical body of the female member 145. As previously discussed, the male member 149 is preferably attached to the bottom portion of the handle 49 as represented in FIG. 13. The male member 149 comprises a shaft 1149 and a pin 2149 which can be perpendicularly attached to the shaft 1149. The shaft 1149 and pin 2149 of the male member 149 can be inserted in the female member 145 through the opening 4145 and, as a result, compress the spring member 6145. When the pin 2149 reaches the hollow space located between the bottom portion 2145 and the keyed plate member 3145, the shaft 1149 can be rotated which results in the pin 2149 being also rotated within this hollow space. Once the pin 2149 reaches the groove 5145, the biasing action of the spring member 6145 pushes the pin 2149 within the groove 5145 preventing further rotation of the shaft 1149 and pin 2149 within the female member 145. When the pin 2149 is located within the groove 5145, it is possible to lock and unlock the joint 40 simply by twisting the handle and thus, adjust the angle of the handle relative to the mop head 43. In order to detach the male member 149 from the female member 145, a user can first simply push on the handle 49 in order to remove the pin 2149 from the groove 5145, and then rotate the handle 49 until the pin 2149 coincide with the opening 4145. The shaft 1149 and pin 2149 can then be extracted from the female member 145. One skilled in the art will understand that the female member 145 can be attached to the lower portion of the handle 49 and the male member 149 can be attached to the threaded plug 45 and still provide the same benefits. In addition, the spring member 6145 can be part of the male member 149 rather than the female member 145 and still provide the same benefits. The female and male members 145, 149 can be made of any suitable material capable of sustaining and transferring the force applied to the handle by the user without rupturing. Preferred examples of suitable materials for the female and male members can be metals, alloys, plastics, wood or any combination thereof.

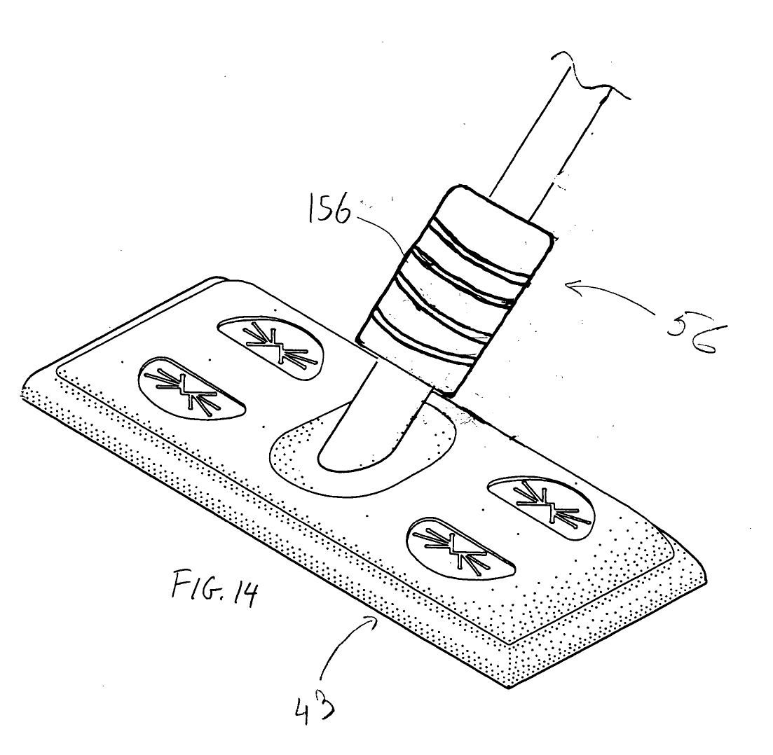

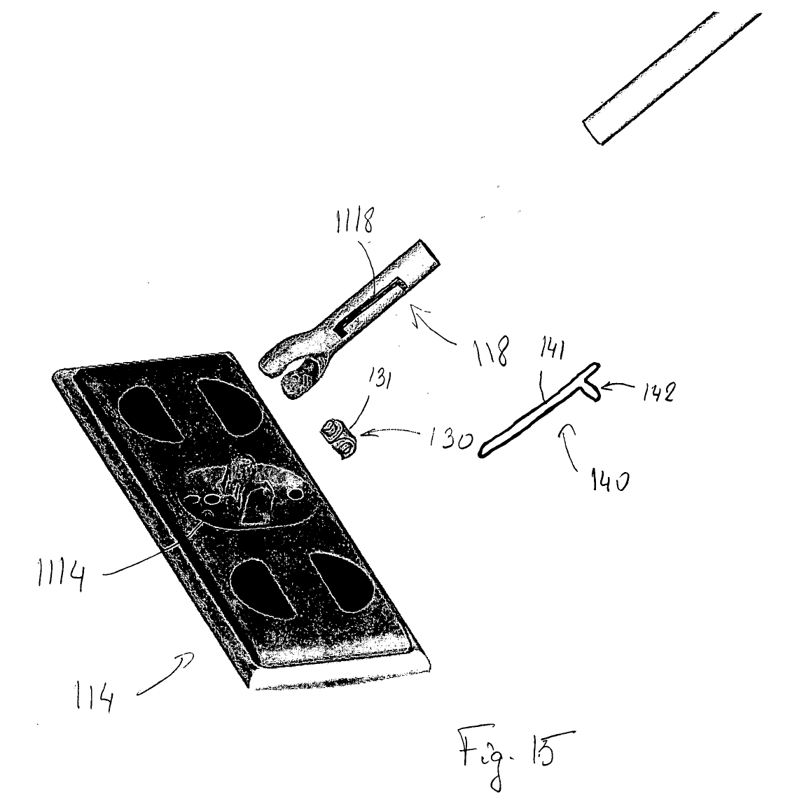

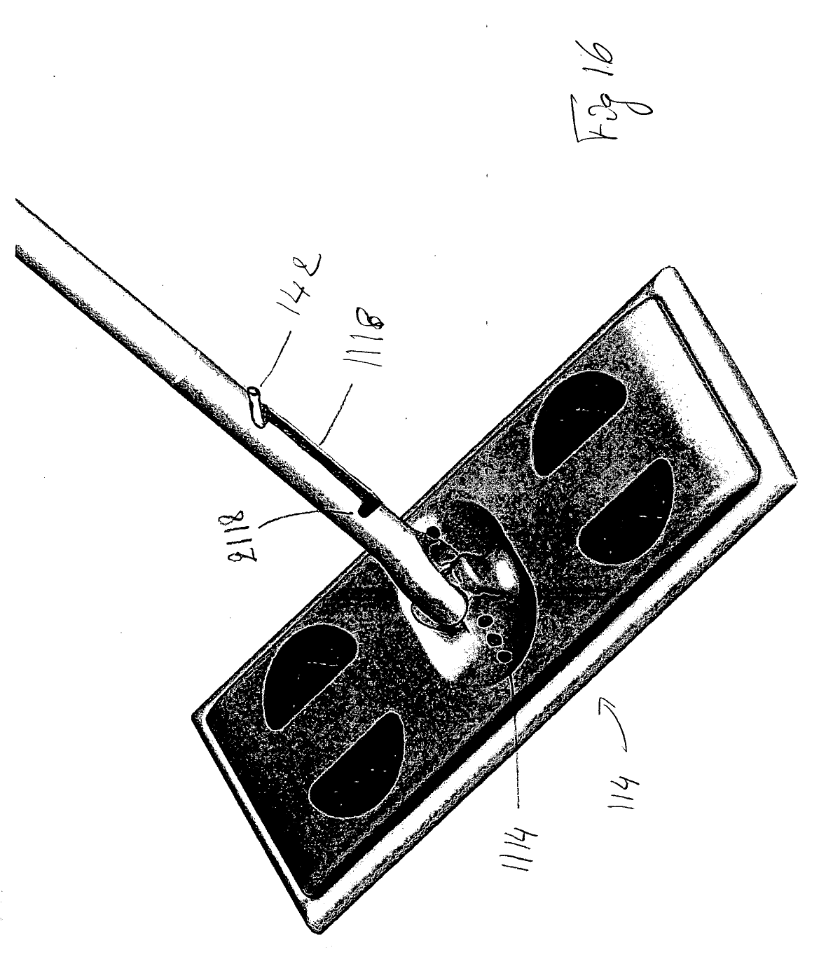

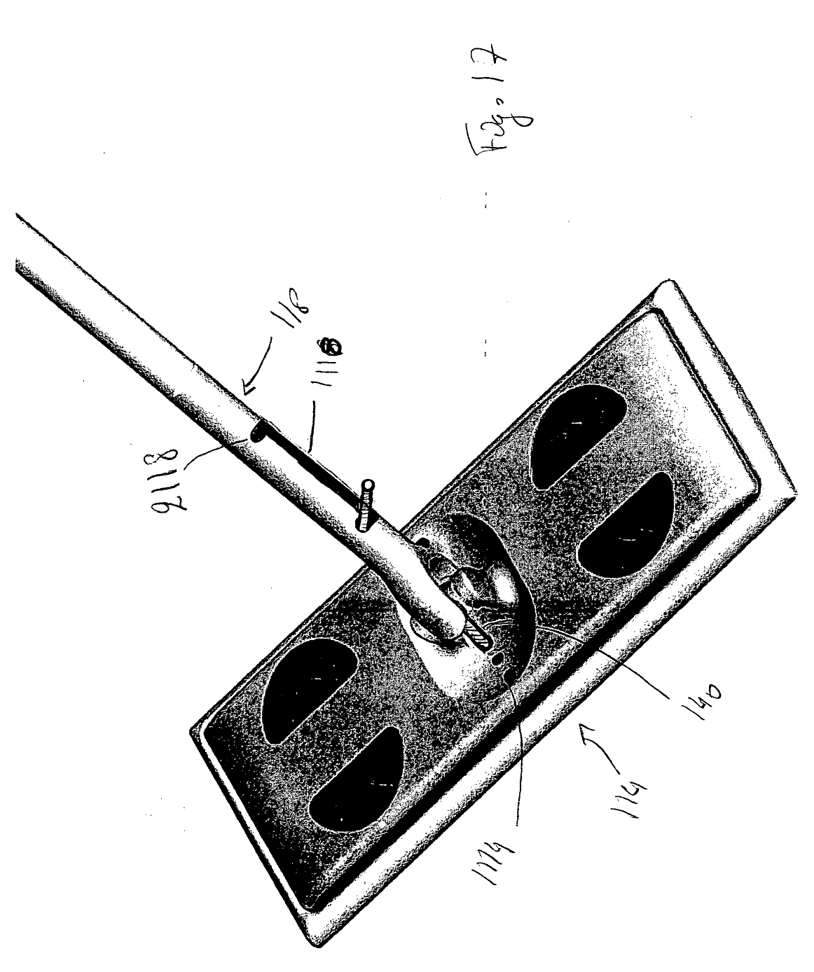

In a preferred embodiment, the threaded plug 45 can be flexibly attached to the handle 49 with a portion of flexible material 56 as represented in FIG. 14. In one embodiment, this portion of flexible material 56 has a substantially cylindrical shape defined by a wall 156 forming an inner volume 256. It might be beneficial that the portion of flexible material 56 have a bellow shape. In a preferred embodiment, the threaded plug 45 is flexibly attached to the handle 49 with the portion of flexible material 56 such that at least a portion of the female member 145 and a portion of the male member 149 are located within inner volume 256 of the portion of flexible material 56. Among other benefits, the portion of flexible material allows the handle to be rotated a full 360° in the x-y plane allowing the mop head 43 to swivel due to the elastic properties of the flexible material and as such to be used with a cleaning sheet or a cleaning pad. Non-limiting examples of suitable cleaning sheets and/or cleaning pads can be SWIFFER® Cleaning sheet and SWIFFER WET® sold by the Procter and Gamble Company and described in detail in co-pending U.S. application Ser. No. 09/082,349 filed May 20, 1998 by Fereshthekhou et al and U.S. application Ser. No. 09/671,718 filed Sep, 27. 2000 by Sherry et al. One skilled in the art will understand that the described floor mops can be used with any other types of cleaning sheets or cleaning pads and still provide the same benefits. In addition, the flexibility and elasticity of the portion of flexible material 56 renders possible to insert the male member 149 into the female member 145 very easily.

In another embodiment of the invention, the female member 145 or the male member 149 can be attached to a mop head at a predetermined fixed angle without requiring an adjustable and lockable joint 40 such as the one which was previously described. In this embodiment, a user can preferably use the implement to clean a hard surface when the male member is not attached to the female member. In addition, a user can use this floor mop with a cleaning sheet comprising protrusions by attaching the male member 149 to the female member 145 in order to obtain a “locked” mop head/handle combination.

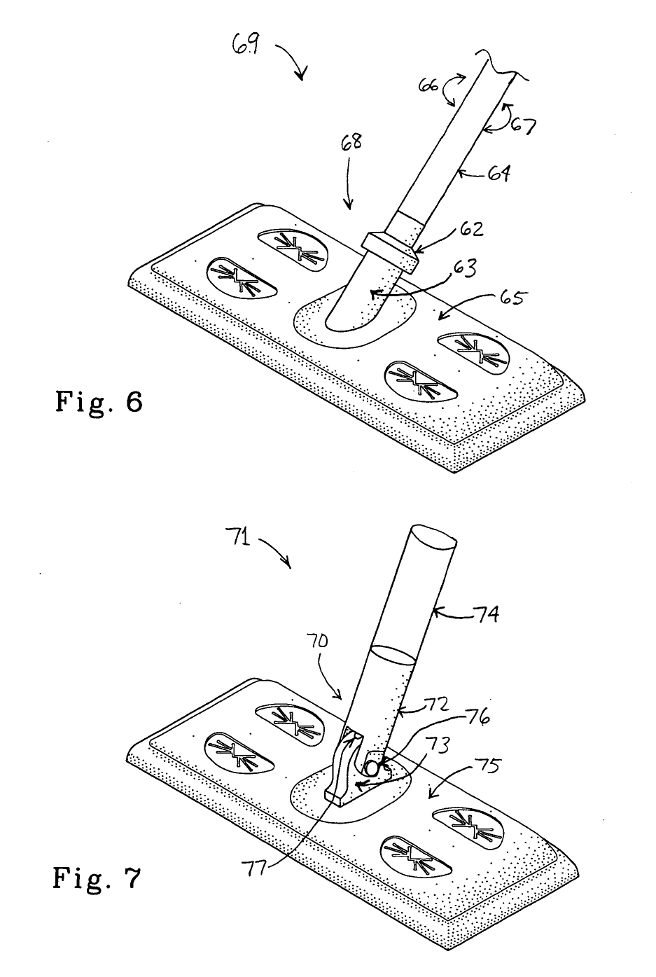

FIG. 6 illustrates another suitable joint 68 for a cleaning implement 69 of the present invention. The joint 68 is a ball-and-socket joint which can be adjusted 360° when in an unlocked position. The joint 68 comprises a handle portion 62 and a base portion 63. The handle portion 62 is connected to a handle 64 and the base portion 63 is connected to a mop head 65 of the cleaning implement 69. The handle portion 62 comprises a socket, through which is extended a threaded portion. The base portion 63 comprises a ball, which receives the threaded portion extending through the socket of the handle portion 62. The joint 68 can be locked by twisting the handle 64 counterclockwise 66 or clockwise 67, depending upon the configuration of the joint 68. As the handle 64 is twisted, the threaded portion extending through the socket of the handle portion 62 engages the ball of the base portion 63, thereby pulling the ball and socket closer together. By continuing to twist the handle 64, the friction between the ball and socket becomes great enough to effectively lock the joint 68 into position. When in a locked position, the angle between the mop head 65 and handle 64 is fixed. The handle 64 can then be twisted in the opposite counterclockwise 66 or clockwise 67 direction to unlock the joint 68, allowing the handle 64 to rotate 360° relative about the joint 68 relative to the mop head 65. Once the desired angle between the mop head 65 and the handle 64 is obtained, the user can again twist the handle 64 in the appropriate counterclockwise 66 or clockwise 67 direction to lock the joint 68 into the desired position.

FIG. 7 illustrates another suitable joint 70 for a cleaning implement 71 of the present invention. The joint 70 comprises a handle portion 72 and a base portion 73. The handle portion 72 is connected to a handle 74 of the cleaning implement 71. The base portion 73 is connected to a mop head 75 of the cleaning implement 71. The handle portion 72 and the base portion 73 have holes therethrough to facilitate a bolt 76 for holding together the handle portion 72 and the base portion 73. The handle portion 72 comprises a spring-loaded ball and the base portion 73 comprises a plurality of recesses 77. The spring-loaded ball of the handle portion 72 can engage a recess 77 of the base portion 73, thereby locking the joint 70 into the desired position. The user can apply force to the handle 74 to dislodge the spring-loaded ball from the recess 77 and move the spring-loaded ball to the next adjacent recess 77 of the base portion 73, thereby adjusting the angle between the mop head 75 and the handle 74 of the cleaning implement 71.

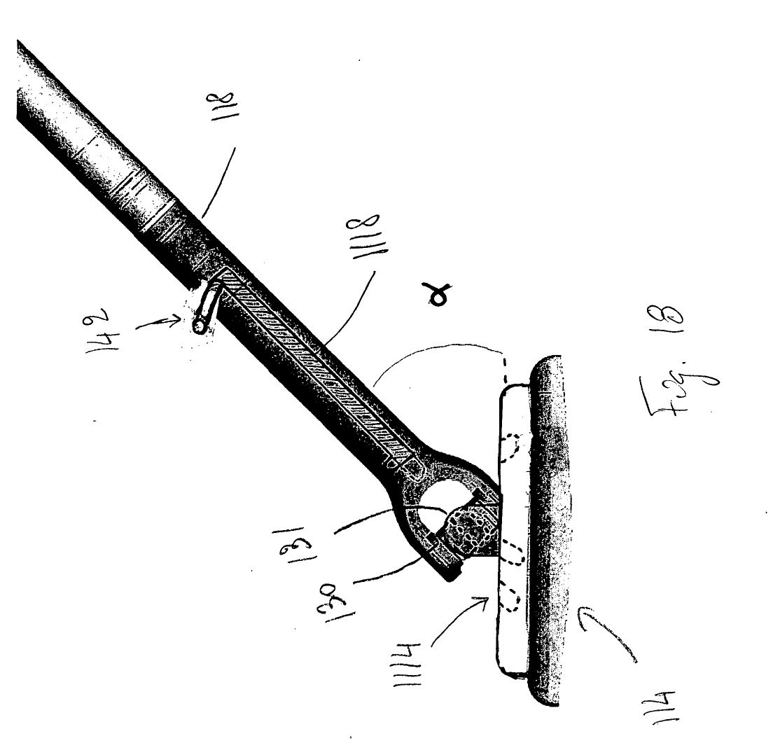

FIG. 15 through 34 illustrate other types of suitable adjustable and lockable joints for a cleaning implement of the present invention.

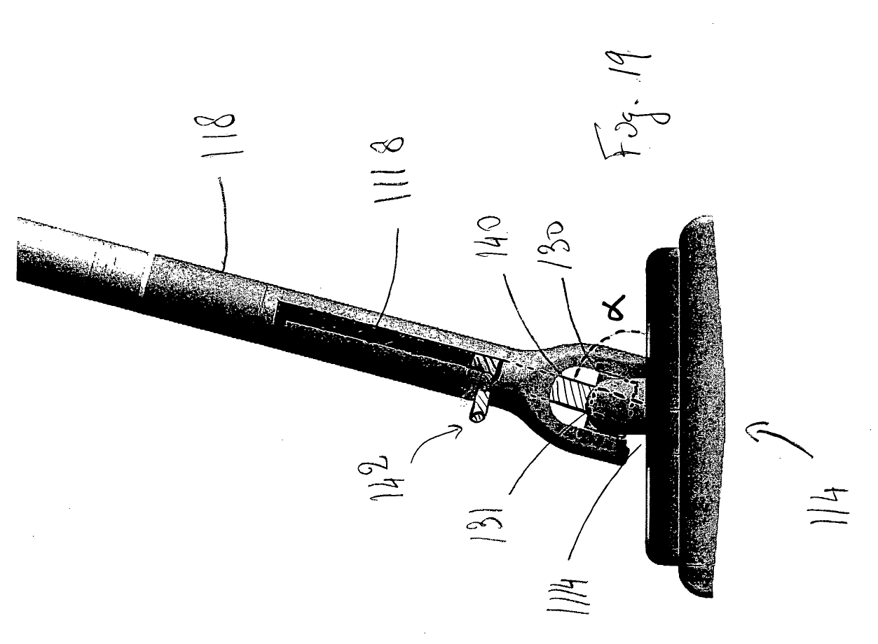

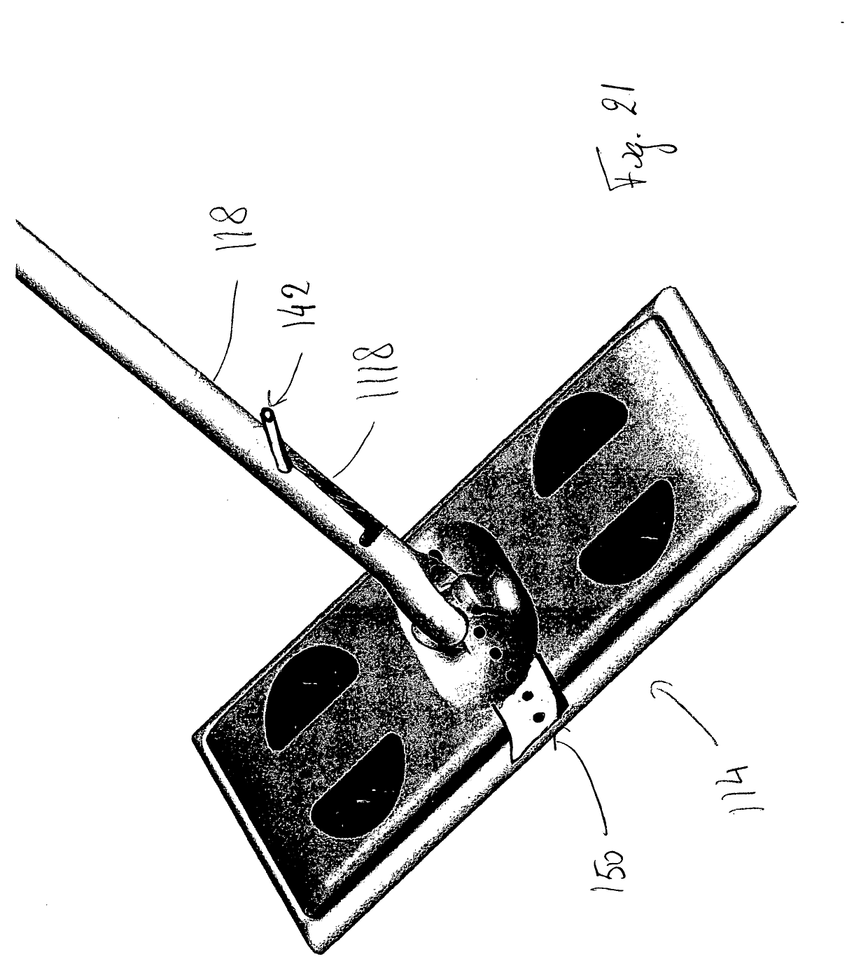

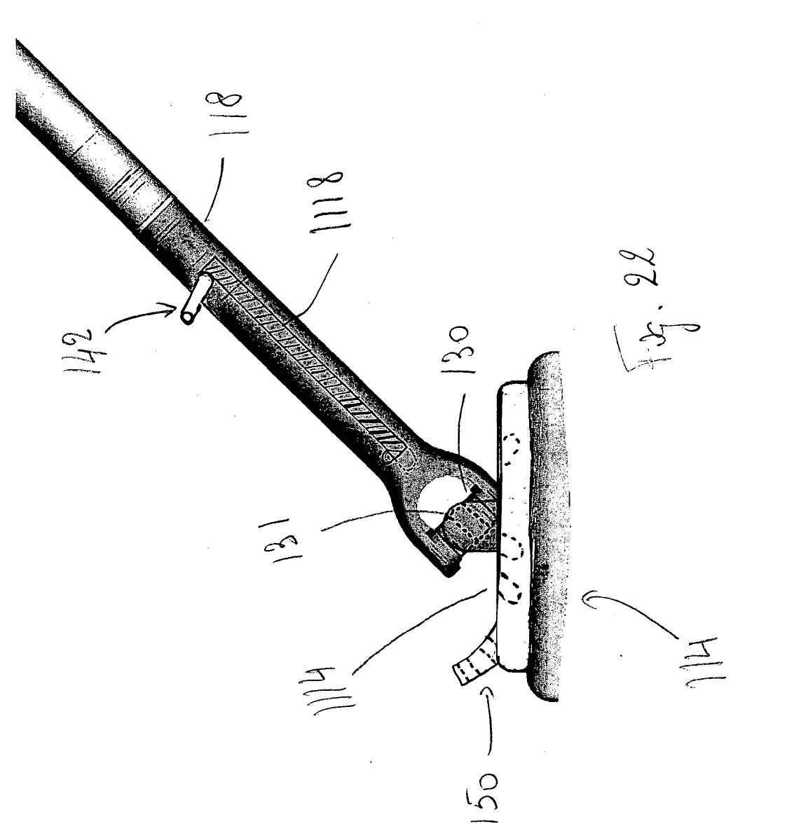

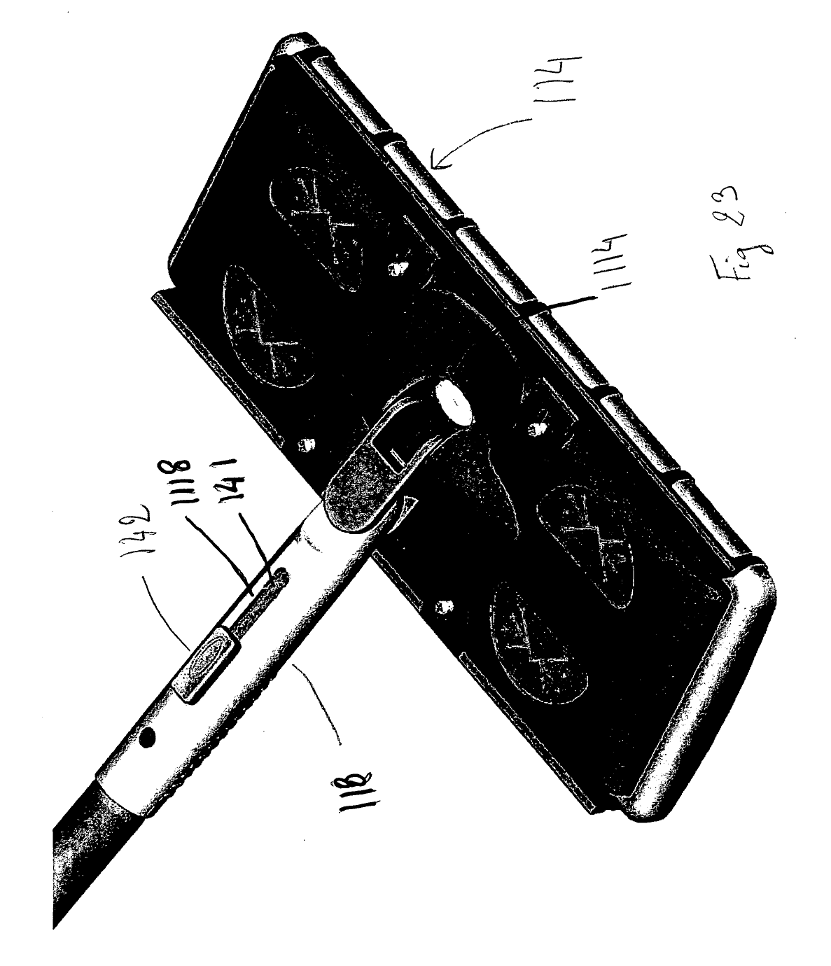

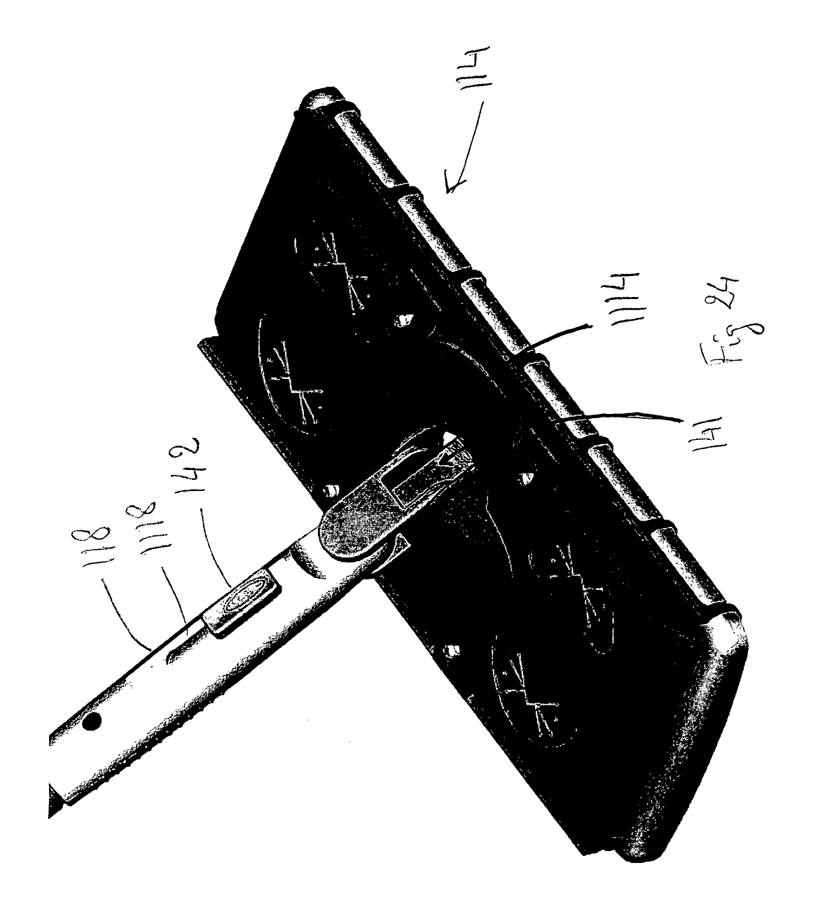

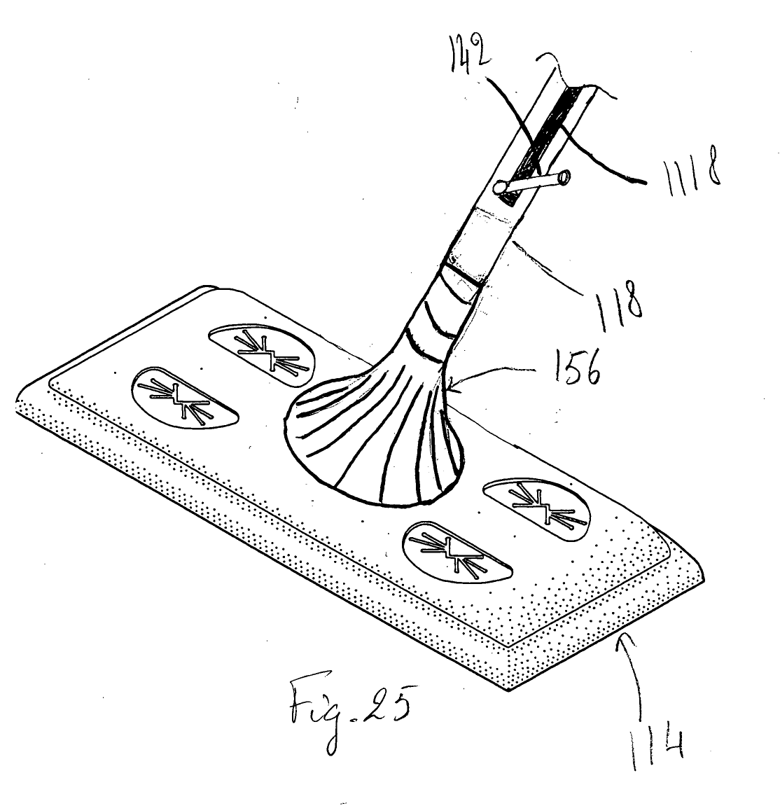

In one embodiment, represented in FIG. 15-22, the floor mop comprises a mop head 114, a handle portion 118 pivotally connected to the mop head 114 by a universal joint 130 and a slideable locking member 140 located within the handle portion 118. The universal joint 130 of this embodiment has two rotational axis which can be located on the same plane. An example of a suitable universal joint can have a substantially cross shape. The slideable locking member 140 can be a longitudinal pole 141 having an arm member 142 perpendicularly attached to the longitudinal pole 141 as represented in FIG. 15. One skilled in the art will understand that the longitudinal pole 141 can have any geometrical shape or form such as circular, triangular or rectangular. It can be preferred to have the slideable locking member 140 made of a relatively stiff or rigid material such that the it does not deform or bend which would prevent it from being slideably movable through the universal joint 130. Non-limiting examples of suitable material can be metals, alloys, plastics, wood or any combination thereof. A slit 1118 on the side of the handle portion 118 allows the slideable locking member 140 to be moved from a first position to a second position by pushing or pulling the arm member 142. As previously discussed, it might be beneficial to adjust the angle of the handle portion 118 relative to the mop head 118 and lock it in place when the cleaning implement is used with a cleaning sheet having protrusions. In order to achieve this result, the mop head 114 comprises at least 1, preferably between 1 and 10, more preferably between 2 and 6 holes, recesses, notches or projections 1114 which can be engaged by the slideable locking member 140. The slideable locking member can be pushed through a central opening 131 of the universal joint 130 in order to engage one of the hole or projection 1114 on the mop head 114. When the slideable locking member is in a first position, as represented in FIGS. 16, 18, 21-23, the handle portion 118 can be rotated a full 360° in the x-y plane allowing the mop head 114 to swivel and as such can be used with a cleaning sheet or a cleaning pad. When the slideable locking member 140 is in the second position, i.e. is pushed through the central opening 131 of the universal joint 130 and engages a recess 1114 on the mop head 114 as represented in FIGS. 17, 19, 20 and 24, the universal joint is locked and the angle between the handle portion 118 and the mop head 114 is fixed. One skilled in the art will understand that the closer a hole or projection 1114 is located to the leading or trailing edge of the mop head 114, the smaller is the angle α between the handle portion 118 and the mop head 114, as shown in FIGS. 19 and 20. It can be beneficial that the holes or recesses 1114 be located on the mop head such that the angle α is comprised between about 0 and about 90 degrees, preferably between about 20 and about 70 degrees, more preferably between about 35 and about 55 degrees. One skilled in the art will understand that the length of the longitudinal pole 141 can be substantially equal to or smaller than the length of the entire handle of the cleaning implement. In a preferred embodiment, the length of the pole member 141 and the slit 11 18 are such that the pole member can engage any of the holes or projections 1114 on the mop head. In one embodiment, these holes or projections 1114 can all be located on the same side of the mop head 114. In another embodiment, these holes or projections 1114 can be located on both sides of the mop head 114 as represented in FIG. 16-18. Considering that the width of a existing mop head is typically comprised between about 100 mm and about 200 mm, one skilled in the art will understand that the angle α can be limited and will be greater than 0 degrees, i.e. the angle at which the handle portion can be parallel to the plane of the mop head 114. In order to solve this problem, an extension 150, comprising further holes or projections and which is schematically represented in FIG. 21 and 22, can be added to the mop head. With this extension 114, it becomes possible adjust and lock the handle at an even smaller angle which can tend to 0 degrees. Optionally, in order to keep the slideable locking member in place in either the first or second position, at least one slit 2118 substantially perpendicular to the slit 1118 can be added to the handle portion 118 as shown in FIGS. 16 and 17. In another embodiment, the slideable locking mechanism can be spring loaded. In yet another embodiment, the hole 1114 on the mop head 114 can be slightly smaller than the longitudinal pole 141 such that the pole 141 can be forced fit into a recess or hole 1114. The projections 1114 can engage and lock a hollow longitudinal pole member 1141. The previously described adjustable and lockable joint can also be used with a universal joint comprising 2 rotational axis which are not in the same plane and the sliding member 140 can be a solid bar. This embodiment is represented in FIGS. 23 and 24.

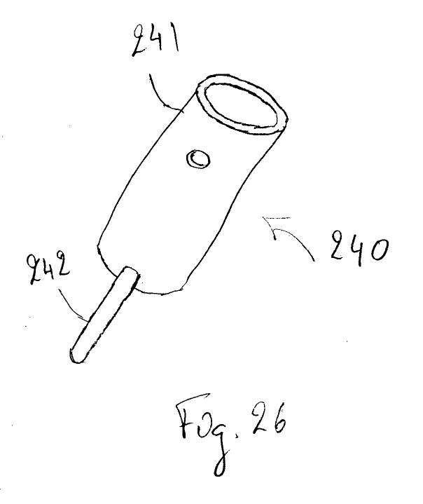

In another embodiment represented in FIG. 25, the floor mop comprises a mop head 114 flexibly attached to a handle portion 118 and a slideable locking member 140 located within the handle portion 118 as previously described. The mop head 114 comprises at least 1, preferably between 1 and 10, more preferably between 2 and 6 projections or holes, recesses, notches 1114 which can engage or be engaged by the slideable locking member 140. The mop head 114 can be flexibly attached to the lower portion of the handle 149 with a portion of flexible material 156 such that the portion of flexible material 156 covers at least partially the projections or holes 1114. The slideable locking member can be moved within the handle portion 118 and the portion of flexible material 156 in order to engage a hole or be engaged by a projection 1114 on the mop head 114. When the slideable locking member is in a first position, the handle 149 can be rotated a full 360° in the x-y plane allowing the mop head 114 to swivel and as such can be used with a cleaning sheet or a cleaning pad. When the slideable locking member 140 is in the second position, as represented in FIG. 25 i.e. is pushed within the handle portion 118 and the portion of flexible material 156 and engages a hole or is engaged by a projection 1114 on the mop head 114, the handle 149 is locked and the angle between the handle 149 and the mop head 114 is fixed which, in turn, allows the user to clean a soft surface with a cleaning sheet comprising protrusions. As previously discussed, the angle of the handle 149 relative to the mop head 114 can be adjusted depending on which hole or projection 1114 the slideable locking member 140 is temporarily attached. In a preferred embodiment, the slideable locking member can be forced fit in a hole or projection 1114 in order to maintain the handle 149 fixedly attached to the mop head 114 during the cleaning of a soft surface.

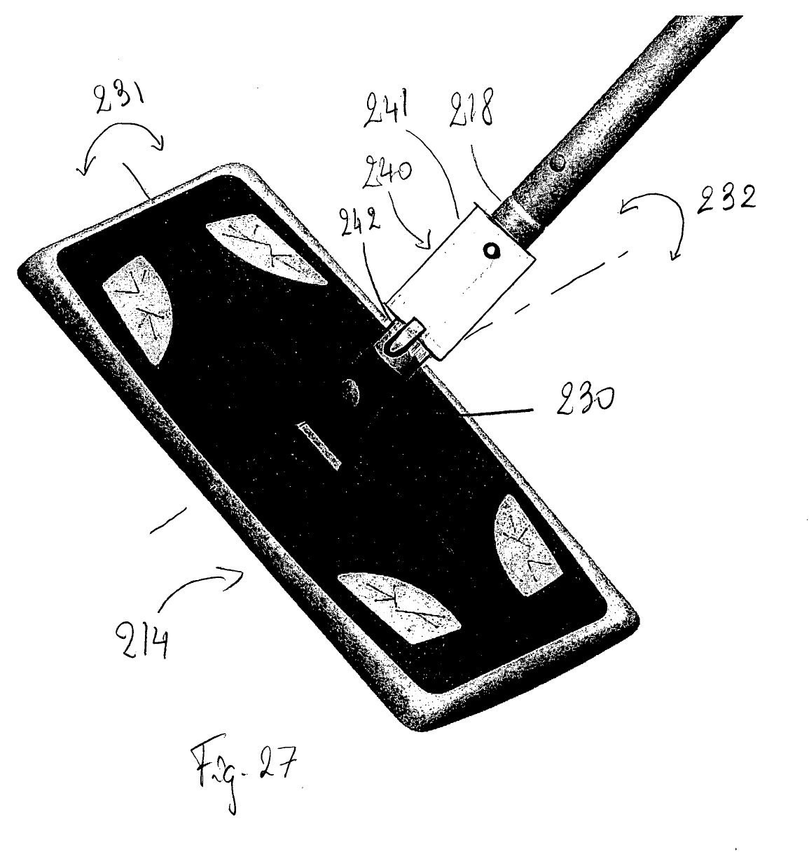

FIG. 26 through 34 illustrate another suitable adjustable and lockable joint for a cleaning implement of the present invention.

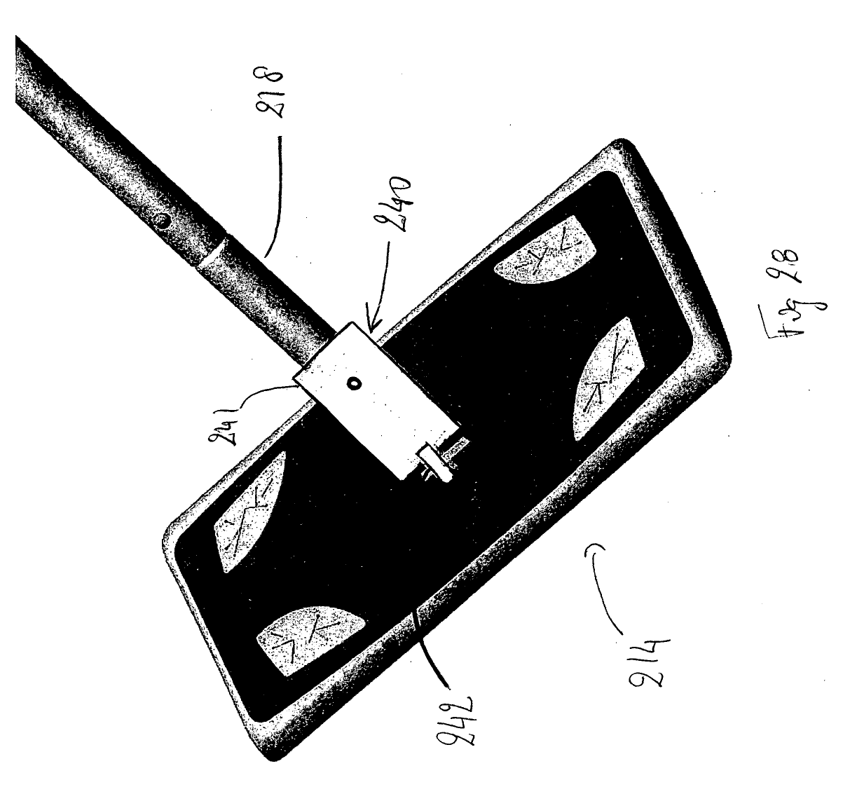

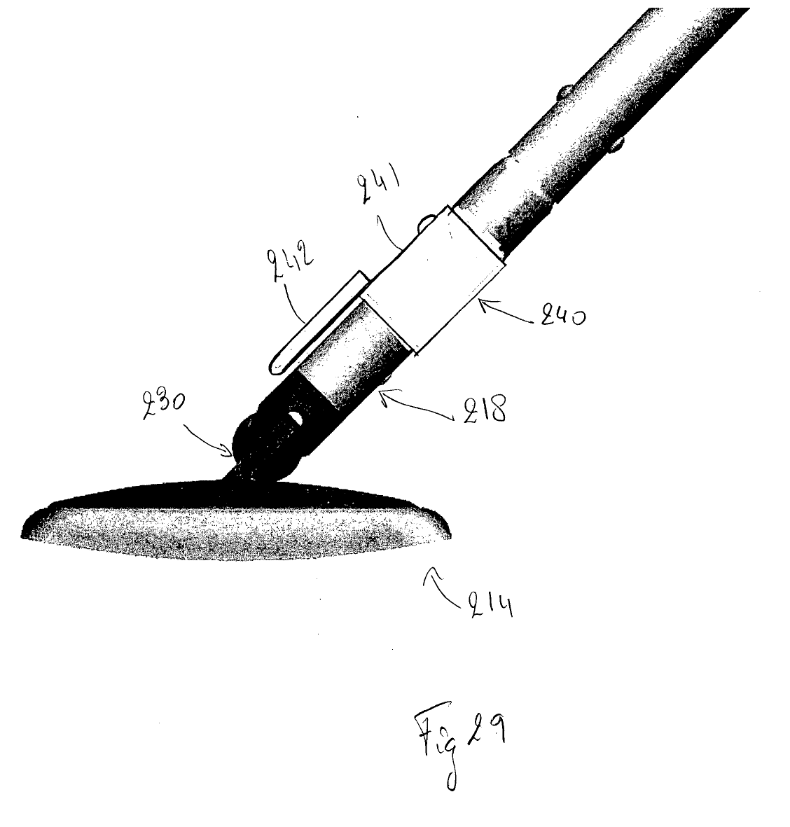

In one embodiment, represented in FIG. 27, the floor mop comprises a mop head 214, a handle portion 218 pivotally connected to the mop head 214 by a universal joint 230 and a slideable locking member 240 which is slideably movable along the outer surface of the handle portion 218. The universal joint 230 of this embodiment has two rotational axis 231 and 232 which can be located in two different planes and are substantially perpendicular. In this embodiment, the universal joint 230 is rotationally attached to the mop head 214 along a first rotational axis 231 and is attached to the handle portion 218 along a second rotational axis 232. The slideable locking member 240 comprises a collar member 241 and a pole member 242. The collar member 241 has a substantial cylindrical shape and has an inner diameter slightly greater than the outer diameter of the handle portion 218 in order to allow the collar member 241 to be slideably movable along the handle portion 218. One skilled in the art will understand that the collar member 241 can have any geometrical shape or form such as circular, triangular or rectangular but will preferably have substantially the same shape than the handle portion 218. The pole member 242 can be attached to the collar member at any suitable location but preferably to the front lower portion of the collar member 241. One skilled in the art will understand that the collar and pole members can be two separate pieces attached together or that they can be molded to form one single element and that they can be made of any type of material but preferably of a relatively stiff or rigid material as previously described. In this embodiment, the mop head 214 comprises holes, recesses, notches or projections as previously described. The slideable locking member 240 can be slided along the handle portion from a first position where the handle portion 218 can rotate a full 360° in the x-y plane allowing the mop head 214 to swivel, as represented in FIGS. 27 and 29, to a second position where the joint is locked at a fixed angle, as represented in FIG. 28 and 30-31. When the slideable locking member 240 is slideably moved to the second position, at least a portion of the collar member 241 covers at least one of the rotational axis of the universal joint 230, preferably the second rotational axis 232 as to prevent rotation of the handle portion 218 about this axis. In addition, when the slideable locking member 240 is in the second position, the pole member 242 can engage a hole, recess or notch on the mop head therefore preventing rotation of the handle portion 218 about the first rotational axis 231 of the universal joint 230. The slideable locking mechanism 240 can be locked in place with any of the mechanism previously described.

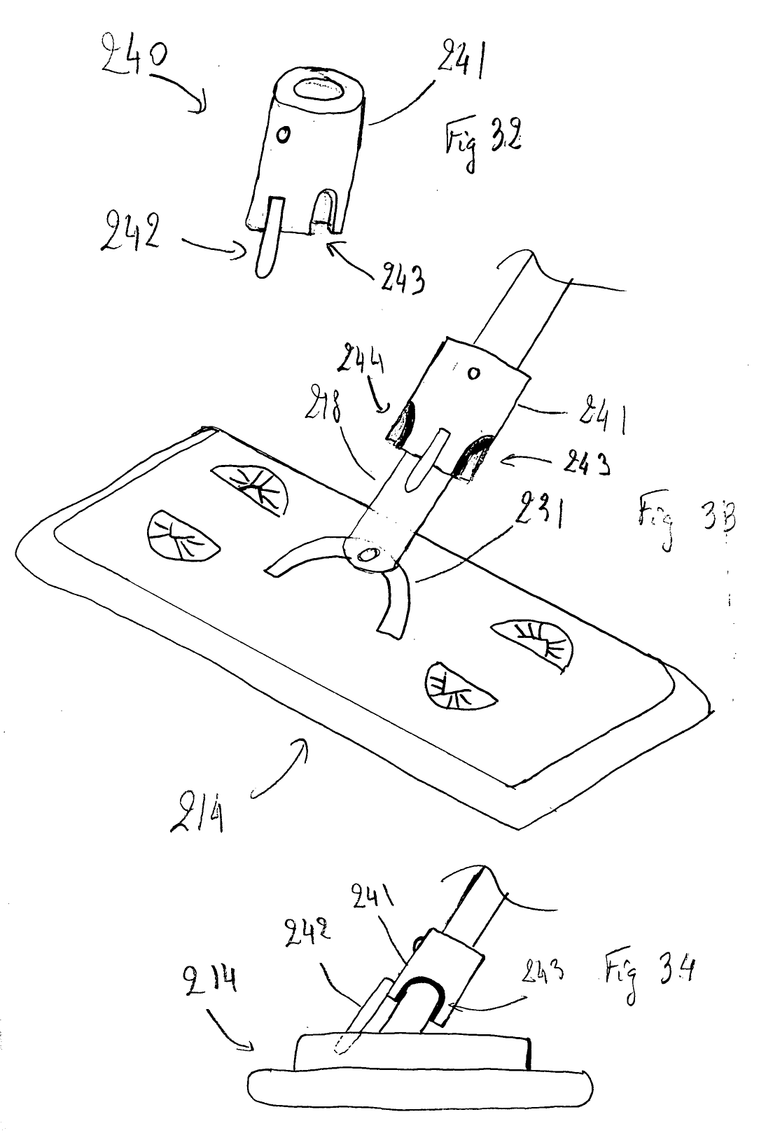

In another embodiment represented in FIGS. 32-34, the universal joint 230 comprises a U-shapped portion 231 rotationally attached to the mop head 214 along a first rotational axis 231 and rotationally attached to a handle portion 218 along a second rotational axis 232. The first and second rotational axis are in different planes and are substantially perpendicular. In this embodiment, it can be beneficial that the collar member 241 comprises a pair of slits or notches 243 and 244 that allow the collar member 241 to cover at least partially the second rotational axis 232 of the universal joint 230.

All the previously disclosed lockable and/or adjustable joints are “integrated” in a floor mop. As a result, consumers who already own a floor mop may have to purchase a new mop having an adjustable and/or lockable joint in order to optimize the use of a cleaning sheet comprising protrusions. In order to avoid the inconvenience of having to purchase a new mop, one aspect of the invention is directed to a separate locking element for locking the universal joint and the handle of a floor mop at a fixed angle.

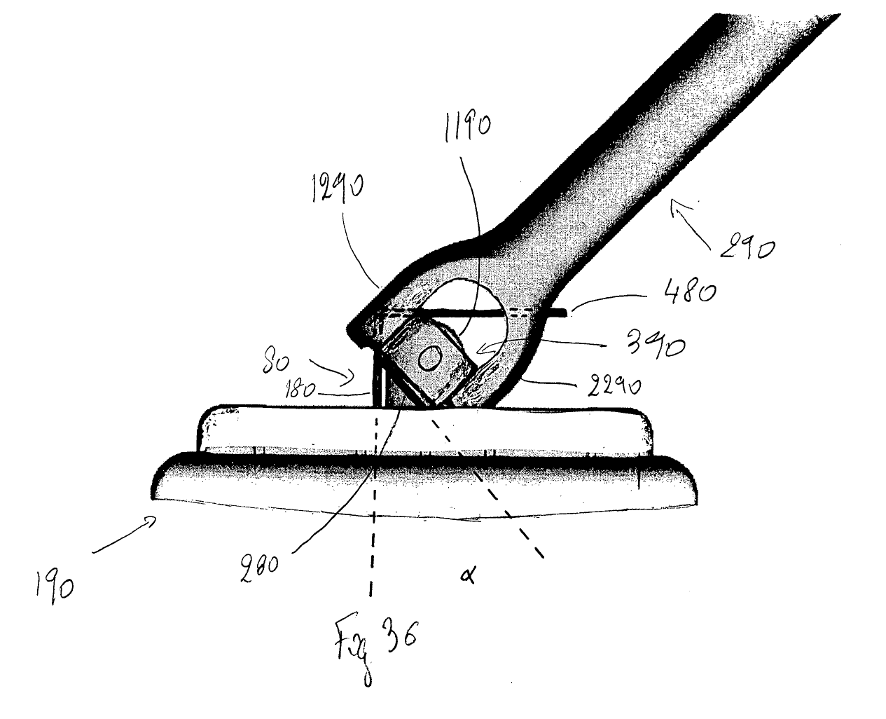

FIGS. 35 through 38 illustrate a suitable locking member for locking the universal joint and the handle of a floor mop at a fixed angle.

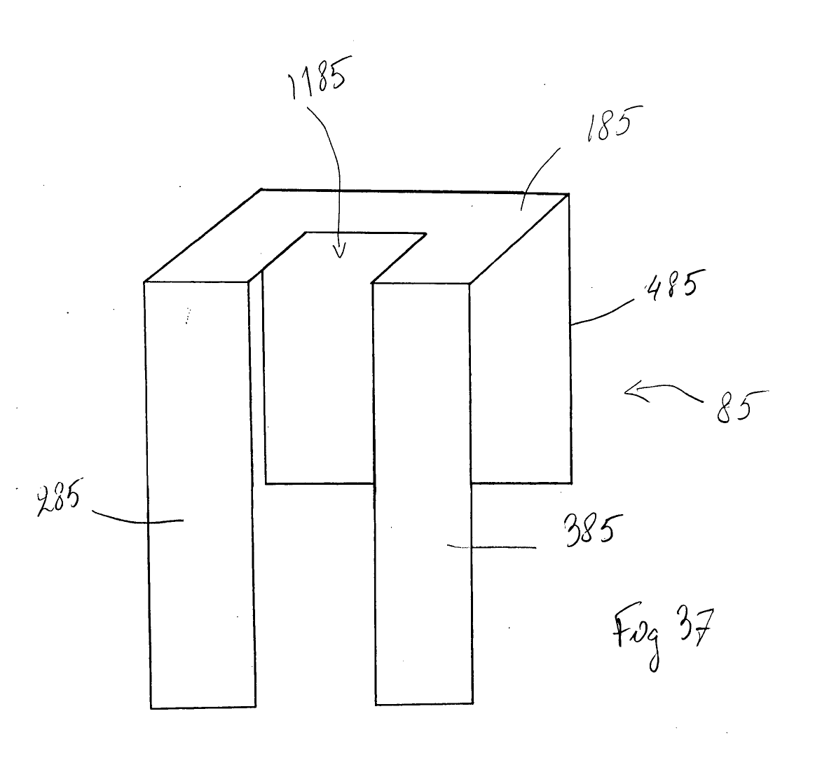

In one embodiment represented in FIGS. 35 and 36, the locking member 80 can be used to lock at a fixed angle the universal joint of a floor mop 90. The floor mop 90 comprises a mop head 190 rotationally attached to a handle 290 with a universal joint 390. In one embodiment, the universal joint 390 can have a substantially cross shape. The universal joint 390 can have a first and a second rotational axis which can be on the same plane. In order to allow a full 360° rotation of the handle 290 in the x-y plane, it can be preferred that the two rotational axis of the universal joint 390 be perpendicular. The mop head 190 comprises two ear members 1190 and 2190 which are attached to the center portion of the top surface of the mop head 190 creating a space in between. The two ear members 1190, 2190 can be rotationally attached to the universal joint 290 along its first rotational axis. The handle 290 comprises a lower portion having two ear members 1290 and 2290 which can have a substantially U shape. The two ear members 1290, 2290 can be rotationally attached to the universal joint 290 along its second rotational axis. In one embodiment, the locking member 80 comprises a support plate 180 which can be substantially flat and has an inner side, an outer side, a top and a bottom edge. By inner side of the support plate 180, it is meant the side which is facing the ear members 1190, 2190 and the universal joint 390 when the universal joint 390 is locked by the locking member 80. By bottom edge, it is meant the edge of the support plate 180 which is the closest to the top surface of the mop head 190 when the universal joint 390 is locked by the locking member 80. A first locking plate 280, for preventing rotation of the handle 290 about the first rotational axis of the universal joint 390, can be attached to the inner side of the support plate 180. In one embodiment, the first locking plate 280 can be attached to the support plate 180 such that the angle between the first locking plate 280 and the support plate 280 is between about 0 and about 90 degrees, preferably between about 20 and about 70 degrees, more preferably between about 35 and about 55 degrees. The width of the first locking plate 280 is such that a user can insert the first locking plate 280 between the first and second ear members 1190 and 2190 of the mop head 190. In a preferred embodiment, the width of the first locking plate 280 is slightly greater than the inner distance between the first and second ear members 1190, 2190 such that the first locking plate 280 can be force fit and/or kept in place between the first and second ear members 1190, 2190. In addition, the first locking plate 280 can be attached to the support plate 180 such that a user can insert the first locking plate 280 underneath the universal joint 390. In a preferred embodiment, the first locking plate 280 is attached to the support plate 180 such that it is substantially adjacent to the tip of the ear member 1290 of the lower portion of the handle 290 when a user inserts the first locking plate 280 between the ear members 1190 and 2190. In this embodiment, the length of the first locking plate 280 can be such that the first locking plate 280 extends beyond the first rotational, axis of the universal joint 390 when a user inserts the first locking plate 280 between the ear members 1190 and 2190. In a preferred embodiment, the length of the first locking plate 280 can be substantially equal to the outer distance between the first and second ear members 1290 and 2290 of the handle 290. In an even preferred embodiment, the first locking plate 280 is attached to the support plate 180 such that the longitudinal axis of the handle 290 is substantially perpendicular to the first locking plate when the first locking plate is inserted between the first and second ear members 1190, 2190 of the mop head 190. One skilled in the art will understand that when the first locking plate 280 is inserted as previously described, rotation of the handle 290 about the first rotational axis of the universal joint 390 is limited and preferably prevented since each ear members 1290, 2290 of the handle 290 might come in contact with the first locking plate 280. As a result, the angle between the handle 290 and the mop head 190 is fixed and this angle is substantially equal to the angle between the first locking plate 280 and the support plate 180.

In another embodiment, the locking member 80 can comprise a second and a third locking plate 380, 480 for preventing rotation of the handle 290 about the second rotational axis of the universal joint 390. In this embodiment, the second and third locking plate can be attached to the support plate 180 defining a space in between, such that the handle 290 can be located between the second and third locking plate 380, 480 when the handle is locked by the locking member 80. In one embodiment, it can be preferred to attach the second and third locking plate adjacent the top edge of the support plate 180. The distance between the second and third locking plate 380, 480 can be substantially equal to, but preferably slightly smaller than, the width of the ear members 1290 and 2290 of the handle 290. In another embodiment, the distance between the second and third locking plate 380, 480 can be substantially equal to, but preferably slightly smaller than, the width or diameter of the handle 290. In one embodiment, the second and third locking plates 380, 480 are attached to the support plate 180 such that the angle between the locking plates 380, 480 and the support plate 180 is comprised between about 20 and about 160 degrees, preferably between about 50 and about 120 degrees and more preferably between a bout 75 and 105 degrees. When a user insert the first locking plate 280 between the ear members 1190, 2190 of the mop head and the first rotational axis of the universal joint 390 is locked, the handle 290 is “sandwiched” between the second and third locking plates 380, 480. As a result, rotation of the handle 290 about the second rotational axis of the universal joint 390 is prevented.

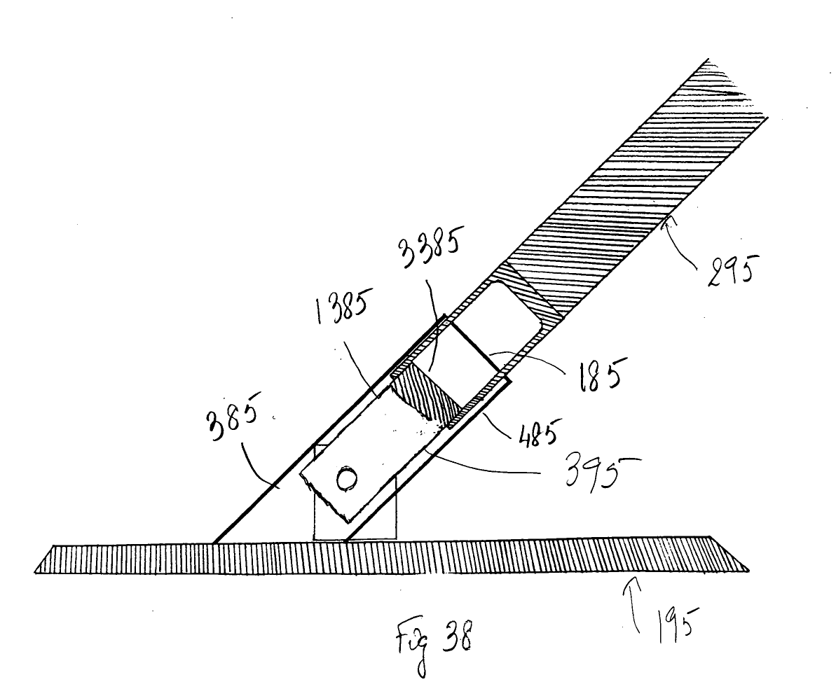

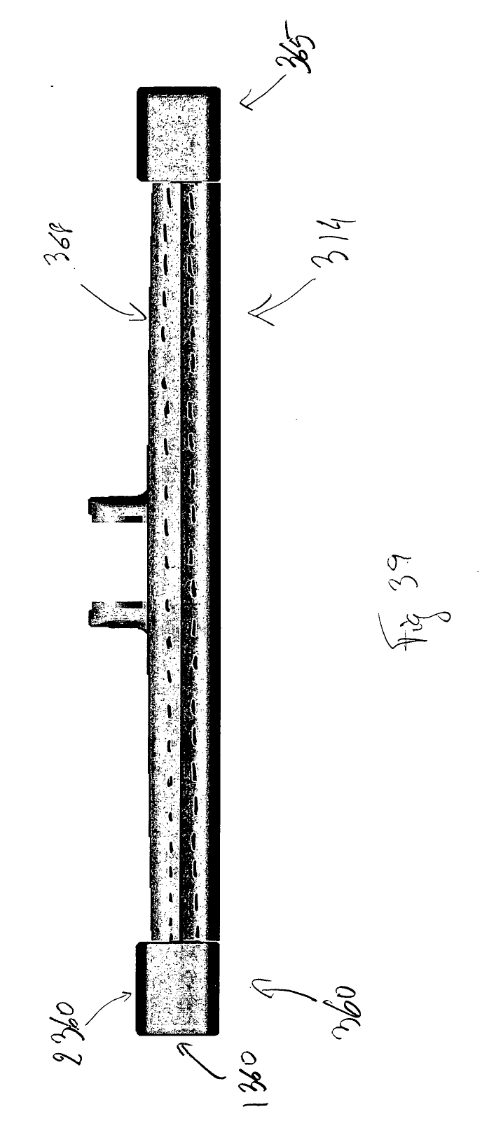

In another embodiment of the invention represented in FIGS. 37 and 38, a floor mop can have a universal joint 395 which can have a first and a second rotational axis which are in different planes. As previously discussed, it might be preferred that the first and second rotational axis of the universal joint be perpendicular. In this embodiment, the universal joint 395 can have a substantially U or V shape. The U or V shape member has a first and a second leg member 1385, 2385 and a top 3385. A mop head 195 can be rotationally attached to each leg 1385 and 2385 along a first rotational axis. A handle 295 can be rotationally attached to the top 3385 of the U or V shape universal joint 385 along a second rotational axis. A locking member 85 can be used to lock at a fixed angle the U or V shape universal joint. In one embodiment, the locking member 85 comprises a support plate 185 which can have a substantially rectangular shape and having a notch 1185 on one of its side. In one embodiment, the width of this notch can be substantially equal, but preferably slightly smaller than the diameter of the handle 295. The locking member 85 also comprises a first and a second leg 285, 385 attached in a downward direction to one edge of the support plate 185, preferably the edge which comprises the notch 1185 such that the first and second leg 285, 385 are located on each side of the notch 1185 of the support plate 185. The locking member 85 also comprises at least a third leg 485 attached in a downward direction to the opposite edge such that it is facing the first and second legs 285 and 385 of the locking member 85. In one embodiment, the first and second legs 285, 385 are substantially parallel to the third leg 485. In a preferred embodiment, the length of the first and second legs 285, 385 is greater than the length of the third leg 485 such that when the bottom portion of the first, second and third legs are in contact with a top surface of the mop head 195, the angle between any of the legs 285, 385 and/or 485 is between about 0 and about 90 degrees, preferably between about 20 and about 70 degrees, more preferably between about 35 and about 55 degrees. In order to lock the handle 295 at a fixed angle relative to the mop head 195, a user can simply insert the handle 295 through the notch 1185 such that the handle is located within the support plate 185 and then slide the whole locking member 85 along the handle 195 until each leg 285, 385 and 485 is in contact with the top surface of the mop head, as shown in FIG. 38. When the locking member 85 is attached to the mop head as previously described, the first, second and third legs 285, 385 and 485 prevent rotation of the handle 295 about the first rotational axis of the universal joint 395 and the support plate 185 prevents rotation of the handle 295 about the second rotational axis of the universal joint 395

The previously described locking members 80 and 85 can be made of any suitable material. Non-limiting examples of suitable materials can be wood, metal, plastic or any combinations thereof.

A locking member 80 and/or 85 can be sold individually or as a kit comprising at least one locking member 80 or 85 and at least one cleaning sheet comprising a substrate having protrusions affixed to the substrate. Another kit could, in addition, comprise a cleaning implement having an universal joint such as any of the joints previously described. Another possible kit can comprise at least one locking member 80 and/or 85 and at least one, but preferably two gliders which can be removably attachable to the mop head of a floor mop. In another embodiment, at least one locking member 80 and/or 85 can be part of a kit comprising at least one cleaning sheet comprising a substrate having protrusion affixed to the substrate and at least one but preferably two gliders also affixed to the substrate.

It is envisioned that other types of joints can provide the adjustable and lockable features desired herein.

B. Gliders

A second preferred aspect of the present cleaning implements is the incorporation of gliders, preferably on the bottom surface of the mop head of the cleaning implement. Gliders are structures incorporated in the present cleaning implement that facilitate the movement of the cleaning implement across the surface being cleaned. Gliders can take any of a variety of forms, including tapes, coatings, molded pieces, and the like. Gliders in the form of tapes can be adhered directly to the bottom surface of a mop head of the present cleaning implement. Gliders can also be directly molded into the bottom surface of a mop head. Gliders can further encompass molded pieces that can be attached to the mop head.

Gliders are especially important when the cleaning implement is being used with a removable cleaning sheet comprising a substrate and a plurality of protrusions affixed to the substrate, as incorporated by reference hereinbefore. The protrusions of the cleaning sheet, while effective in removing debris from a surface, can pose a problem with respect to the ability of the cleaning implement to smoothly glide across the surface being cleaned, especially soft surfaces such as carpet, upholstery, fabric, and the like. The gliders can significantly enhance the ability of the cleaning implement to smoothly glide across the surface being cleaned.

Gliders can be made of any number of materials, preferably materials having a relatively low coefficient of friction. Suitable materials for making gliders of the present invention include acetals (including polyacetals), polypropylene, polyethylene, ABS, Teflon, and mixtures thereof. Preferred materials for making gliders include acetals and polyacetals. Acetals are derivatives of formaldehyde, and include homopolymers and co-polymers. Acetals are strong and rigid (but not brittle) and have good moisture, heat and chemical resistance. Acetals have a low surface friction in contrast with many other materials and their abrasion is low. The most outstanding properties of polyacetals are high tensile strength, stiffness, resilience, good recovery from deformation under load and toughness under repeated impact. Acetals are thus a preferred material for making gliders. Acetals are commericially available from DuPont under the trade name DELRIN® and from Celanese under the trade name CELCON®.

The present cleaning implement will preferably have at least one glider, but preferably at least two gliders, which are preferably positioned near each of the side edges of the bottom surface of the mop head of the present cleaning implement. In another embodiment, at least one but preferably two gliders can be positioned away from the side edges of the bottom surface of the mop head, preferably the distance between the gliders and the side edges is at least 5 mm, more preferably at least 10 mm and most preferably at least 15 mm. In this embodiment, the floor mop might be used with a cleaning sheet comprising a substrate with protrusions and a corresponding number of notches or cut out for allowing the gliders to extend through these. In this embodiment it might beneficial that the substrate of the cleaning sheet comprise protrusions in the portion of the substrate located between the side edge of the bottom surface of the mop head and the gliders. Among other benefits, such a cleaning sheet can be used for edge and/or corner cleaning of a soft surface.

FIG. 2 is a bottom view of the mop head 14 of the cleaning implement 11 of FIG. 1. FIG. 2 shows that the mop head 14 has two gliders 20 attached thereto. The gliders 20 are positioned at near each of the side edges of the bottom surface of the mop head 14. In this embodiment, the gliders 20 are strips of tape, preferably made of Teflon, adhered to the bottom surface of the mop head 14.

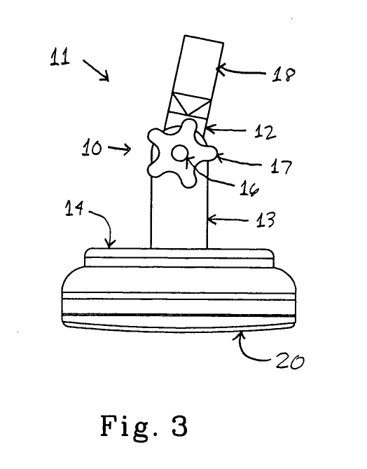

FIG. 3 is a side view of the mop head 14 of the cleaning implement 11 of FIG. 1. FIG. 3 shows that the gliders 20 are relatively thin strips of tape, preferably made of Teflon, and have a slightly curved profile. When a removable cleaning sheet is attached to the cleaning implement 11, the cleaning sheet is generally positioned between the pair of gliders 20. The gliders thus provide some height between the bottom surface of the glider and the bottom surface of the mop head 14, such that the cleaning sheet is not contacted to the surface with as great of force, if the gliders 20 were not present. This facilitates the cleaning implement 11 gliding smoothly across the surface being cleaned, while still allowing the cleaning sheet to remove debris from the surface. In one embodiment, the mop head can comprise a substantially compressible and/or conformable pad. During use of a floor mop having a compressible and/or conformable pad, the pad will tend to be compressed. As a result, the gliders come in contact with the soft surface. In this embodiment, the gliders can be attached to the mop head such that the height of the gliders relative to the bottom surface of the mop head is negative, i.e. the bottom surface of the gliders is further away from the soft surface than the bottom surface of the pad of the mop head. In one embodiment of the invention, the height of the gliders is comprised between about −10 mm and about 15 mm, preferably between about 3 and 9 mm and more preferably between about 5 to 7 mm. By height 120 of the gliders it is meant the distance between the bottom surface of the mop head and bottom surface of the gliders as shown in FIG. 40. In one embodiment, a cleaning implement comprising a pair of gliders attached to the bottom surface of the mop head is used with a disposable cleaning sheet comprising protrusions such as the one described in detail in co-pending U.S. Application Ser. No. 60/300,700 filed Jun. 25, 2001 by Kacher et al. (P&G Case 8604P), U.S. Application Ser. No. 60/300,760 filed Jun. 25, 2001 by Kacher et al. (P&G Case 8605P), U.S. Application Ser. No. 60/370,712 filed Apr. 8, 2002 by Kacher et al. (P&G Case 8604P2), and U.S. Application Ser. No. 60/370,715 filed Apr. 8, 2002 by Kacher et al. (P&G Case 8605P2). In this embodiment, it has been observed that when such a cleaning sheet is attached to the mop head and it is moved across a soft surface, it might be beneficial that at least some of the protrusions of the cleaning sheet, engage or “penetrate” the soft surface. It can be preferred that the engagement ends of the protrusions penetrate into the surface from about 0 to about 4 mm, preferably from about 0 to about 3 mm, even more preferably more about 0.1 to about 2 mm.

Examples of gliders are further shown in FIGS. 4 and 5. The cleaning implement 41 has a pair of gliders 57. The gliders 57 can be adhered to the bottom surface of the mop head 43, can be molded into the mop head 43, can be free-floating with respect to the mop head 43, or the like. FIG. 5 shows spring-loaded gliders 57 that are free-floating with respect to the mop head 43. The spring-loaded gliders 57 are mounted on glider bases 58 through which springs 59 are extended to the gliders 57. The springs 59 extend through the lower base 51 to the upper base 50 of the mop head 43. These gliders 57 are thus capable of rocking back-and-forth as the cleaning implement 41 is moved back-and-forth across the surface being cleaned. This rocking motion of the gliders 57 helps to facilitate the use of a cleaning sheet removably attached to the cleaning implement. Due to the spring-loaded gliders the height of the gliders can vary relative to the bottom surface of the mop head. This varying height can be viewed as a gap between the resting position of the glider and the bottom surface or pad of the mop head. In one embodiment, this gap is comprised between about −1.0 cm and about +2.0 cm, preferably between about 0 cm and about +1.0 cm.

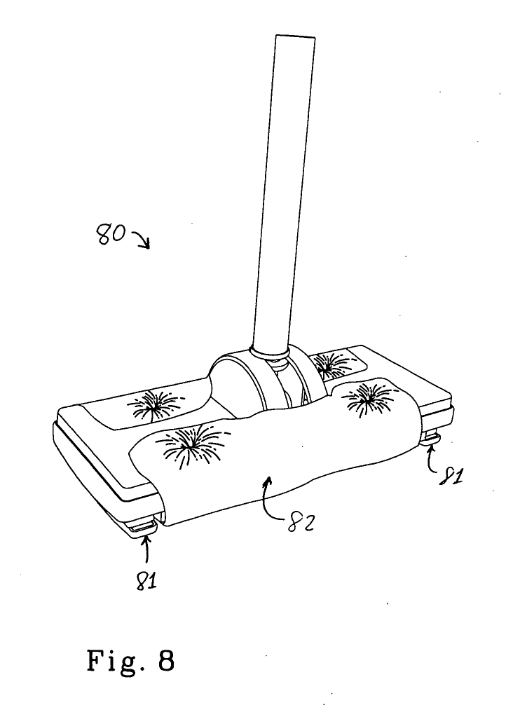

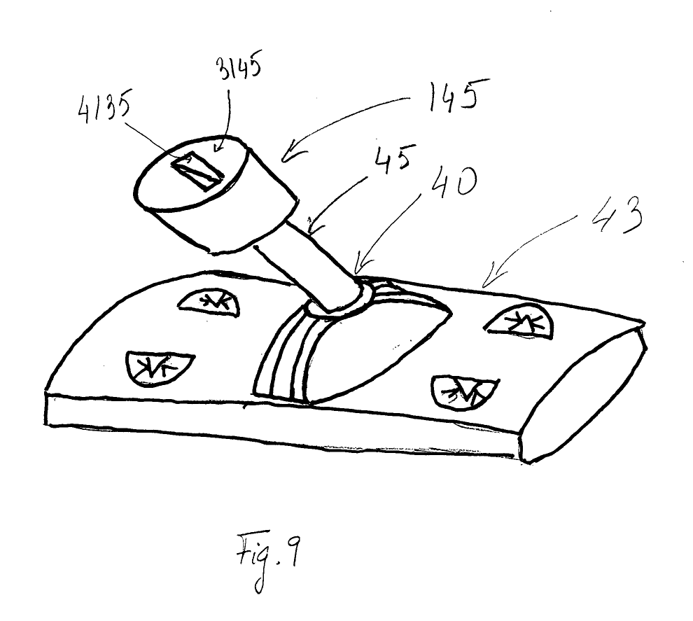

FIG. 8 shows a cleaning implement 80 comprising gliders 81 having a removable cleaning sheet 82 affixed thereto. The cleaning sheet 82 is positioned between the pair of gliders 81.

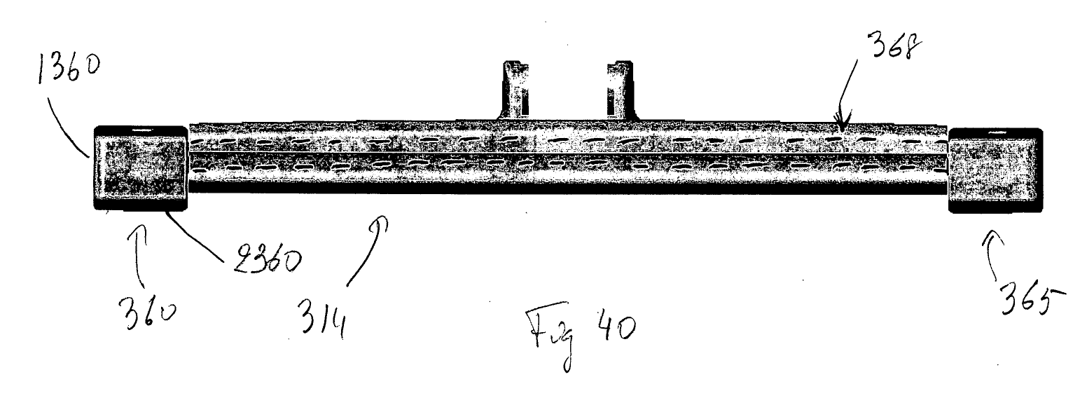

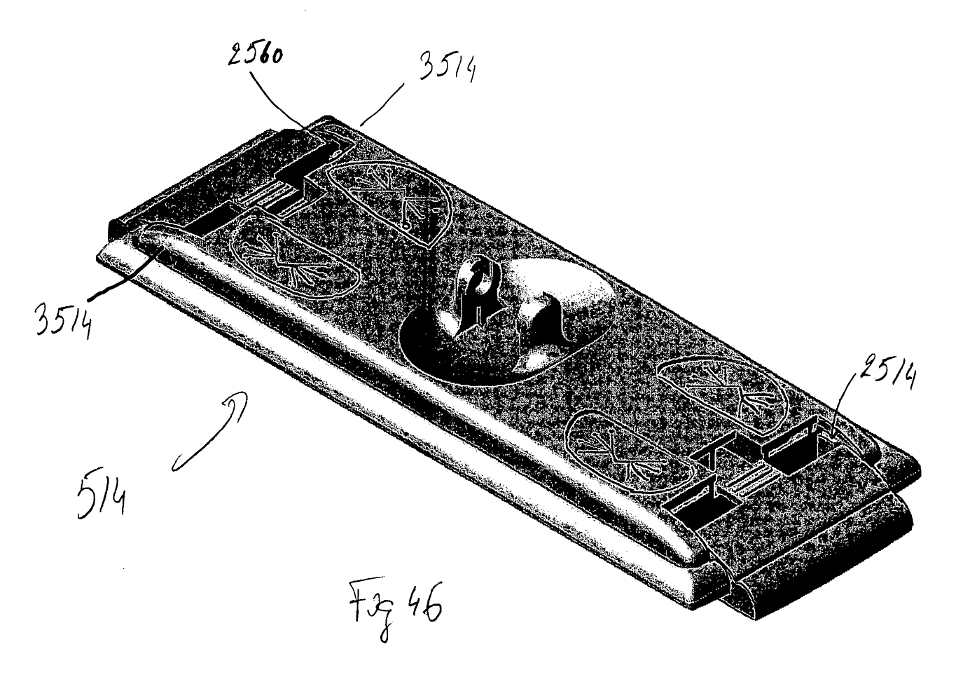

FIG. 39 through 56 illustrate another mop head comprising gliders for a cleaning implement of the present invention.

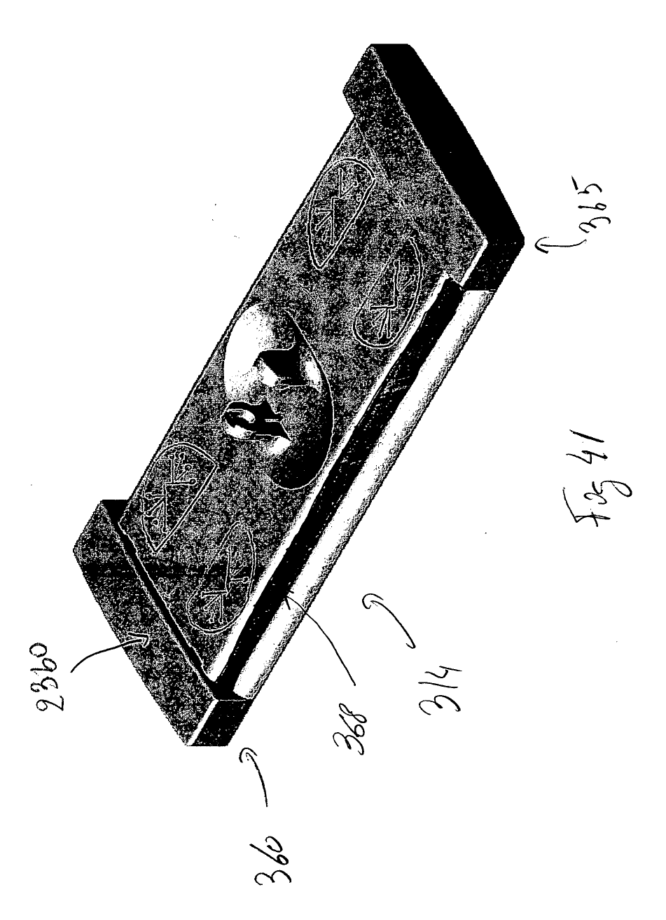

In one embodiment, represented in FIGS. 39-41, the floor mop comprises a mop head 314 having an top and a bottom surface, a left and a right side where a first and a second gliding member 360 and 365 are rotationaly attached. In one embodiment, the first and second gliding members are rotationally attached to respectively the left and right side of the mop head 314 along the rotational axis. In this embodiment, each gliding member comprises a body portion 1360 having an upper surface and a lower surface and at least one glider 2360 attached to the lower surface of the body portion 1360. One skilled in the art will understand that alternatively, the glider(s) can be attached to the upper surface of the body portion 1360 and provide the same benefits. Each gliding member 360 and 365 can be rotationally moved from a first to a second position. When a gliding member 360 or 365 is in the first position, as represented in FIG. 40, the at least one glider 2360 is located adjacent the bottom surface of the mop head 314. As a result, the cleaning implement can be used as previously described with a cleaning sheet having protrusions to clean soft surfaces. When a gliding member 360 or 365 is in the second position, as represented in FIG. 39, the at least one glider is located adjacent the top surface of the mop head 314 which allows the cleaning implement to be used with a cleaning sheet or a cleaning pad in order to clean hard surfaces. It can be preferred that when the gliding member 360 or 365 is in the second position, the upper surface of the body portion 1360,which is now facing the surface to be cleaned, has the same height and/or curvature than the bottom surface of the mop head 314 such that they coincide and the mop head has a substantially smooth and/or continuous bottom surface. In one embodiment, the gliding members 360 and 365 can be rotated or flipped from the first to the second position and vice versa, independently. A user can simply rotate these gliding members depending on the kind of cleaning sheet she wants to use and the kind of surface she wants to clean. It can be preferred to allow the user to rotate both gliding members 360 and 365 by simply actuating one of these gliding members. This can be done very simply by mechanically connecting each gliding members 360 and 365 with a pole 368 as represented in FIG. 41. This pole 368 assures that the rotation of one of the gliding member 360 or 365 will result in the rotation of the other gliding member. Optionally, the mop head 314 can comprise at least one but preferably two retaining members in order to retain the pole 368 in place when the cleaning implement is being used. In order to rotate the gliding members 360 and 365, a user needs to overcome the “retaining force” which assures that the pole 368 and the gliding members are kept in place. These retaining members 1314 can be a notch, a groove, a clip or any equivalent known in the art. A retaining member 1314 can adjacent at least one of the edges of the mop head. In a preferred embodiment, the mop head 314 comprises one retaining member on its leading edge and one retaining member on its trailing edge. In one embodiment of the invention, the pole 368 is attached at both ends to the first and second gliding members 360 and 365 and is located substantially adjacent the rotational axis of the first and second gliding members as represented in FIGS. 39-40. In this embodiment, the pole 368 is located within the mop head 314. Among other benefits, a pole 368 located within the mop head prevents a user to inadvertently damage the pole 368 but also prevents the user to have his hand or fingers pinched by the pole 368 during the rotation of the gliding members.

In another embodiment, the first and second gliding members 360, 365 can be removably attached to the mop head 314, preferably to the left and right side of the mop head. In this embodiment, a user can very simply attach each gliding member to left and right side of the mop head such that the gliders 2360 and 2365 are located substantially adjacent the bottom surface of the mop head 314. A user can then use the floor mop with a cleaning sheet comprising protrusions to clean a hard surface. If desired, a user can remove each gliding members 360, 365 from the mop head in order to rotate them and reattach each gliding members such that the gliders 2360 and 2365 are located adjacent the top surface of the mop head 314. A user can then use the floor mop to clean a hard surface with a cleaning sheet or a cleaning pad. There might be multiple ways to removably attach each gliding member 360, 365 to the left and right side of the mop head. For example, the gliding members can be clipped to the mop head, forced fit on the mop head or removably attached using hooks and loops fasteners or any pressure sensitive adhesive.

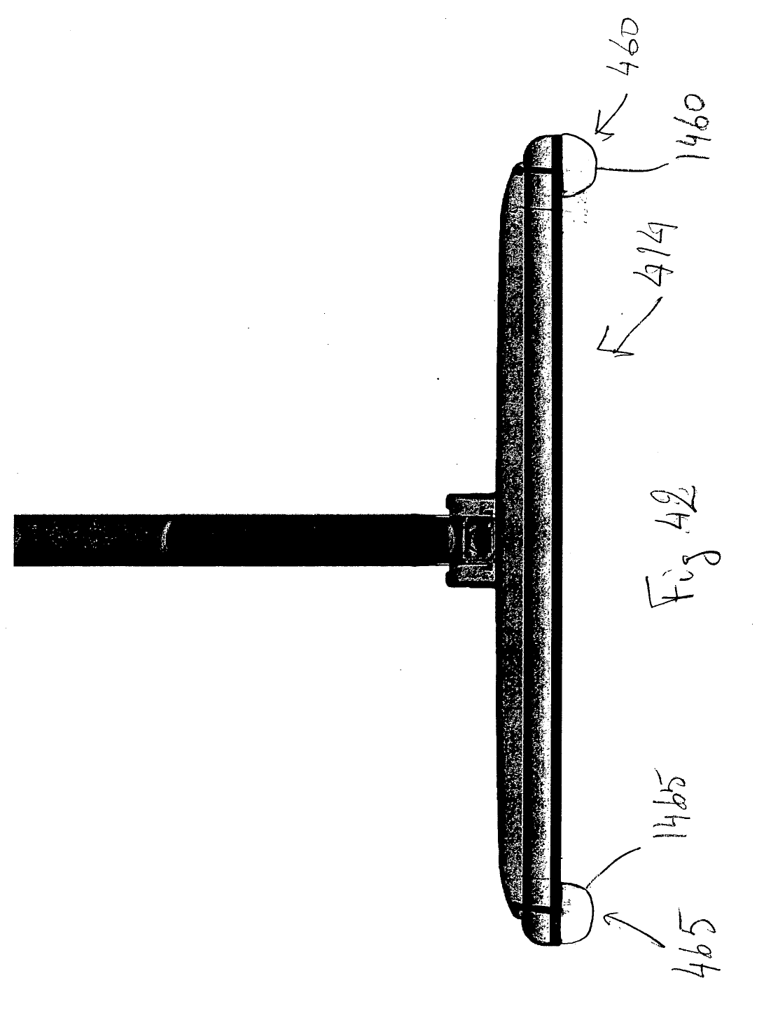

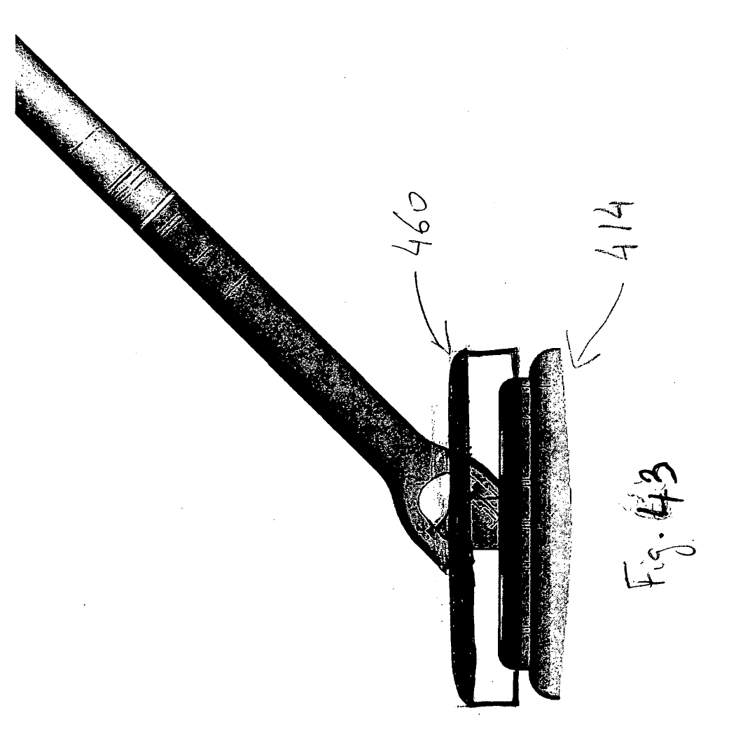

In one embodiment, represented in FIG. 42-43, the floor mop comprises a mop head 414 having an top and a bottom surface, a left and a right side where a first and a second gliding member 460 and 465 are hingedly attached. In one embodiment, the first and second gliding member each comprise at least one glider 1460 or 1465 which are hingedly attached to respectively the left and right side of the mop head 414. Each gliding member 460 and 465 can be hingedly moved, i.e. flipped, from a first to a second position. When a gliding member 460 or 465 is in the first position, as represented in FIG. 42, the at least one glider 1460 or 1465 is located adjacent the bottom surface of the mop head 414. As a result, the cleaning implement can be used as previously described with a cleaning sheet having protrusions to clean soft surfaces. When a gliding member 460 or 465 is in the second position, as represented in FIG. 43, the at least one glider is flipped away from the bottom surface of the mop head 414 which, in turn, allows the cleaning implement to be used with a cleaning sheet or a cleaning pad in order to clean hard surfaces.

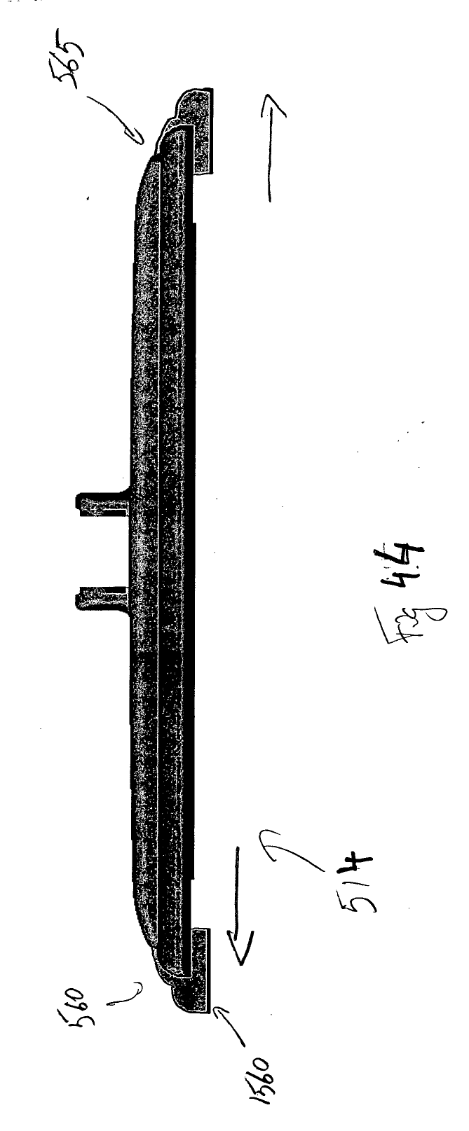

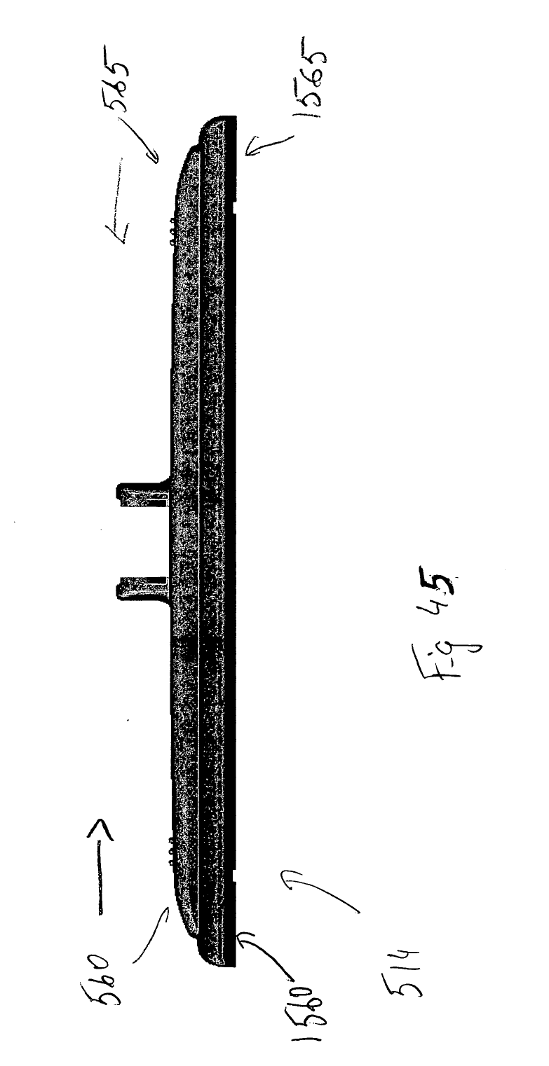

In one embodiment, represented in FIG. 44-46, the floor mop comprises a mop head 514 having an top and a bottom surface, a left and a right side where a first and a second gliding member 560 and 565 are slideably attached. In one embodiment, the first and second gliding members are slideably attached to respectively the left and right side of the mop head 514. In this embodiment, each gliding member can comprise at least one glider 1560 having a bottom surface and at least one but preferably two projections 2560 and 3560 attached to opposite sides of the body portion 1560. These projections engage and are slideably movable within corresponding grooves or guide members 2514 located within at least one but preferably a pair of “ears” members 3514 on each of the left and right side of the mop head 514. These grooves or guide members can be made such that when a user pulls a gliding member 560 or 565 in a direction depicted by an arrow in FIG. 44, this gliding member comes to a first position. When a gliding member 560 or 565 is in this first position, as represented in FIG. 44 and 46, the at least one glider 1560 is extending from the bottom surface of the mop head 514. As a result, the cleaning implement can be used as previously described with a cleaning sheet having protrusions to clean soft surfaces. As previously discussed, a user can attach a cleaning sheet having protrusions to the mop head such that at least a portion of the cleaning sheet is located between the gliding members 560 and 565. One skilled in the art will then understand that when a user pushes a gliding member 560 or 565 in the direction depicted by an arrow in FIG. 45, this gliding member comes to a second position. When a gliding member 560 or 565 is in this second position, as represented in FIG. 45, the bottom surface of the at least one glider is substantially in the same plane than the bottom surface of the mop head 514 which allows the cleaning implement to be used with a cleaning sheet or a cleaning pad in order to clean hard surfaces. In another embodiment, the at least one but preferably two projections 2560 and 3560 can be attached to the at least one but preferably two “ear” members 3514 on each of the left and right side of the mop head 514. These projections 2560 and 3560 can engage corresponding grooves or guide members 2514 located on the gliding members 560, 565. As previously discussed, a user can simply pull or push the gliding member 560 and 565 depending on the kind of cleaning sheet she wishes to use and the kind of surface she wishes to clean. Optionally but preferably, at least a portion of grooves or guide members 2514 can be slightly narrower than the projections 2560 and 3560 such that a minimum force needs to be overcome in order to slideably move the gliding member from the first to the second position and vice versa.

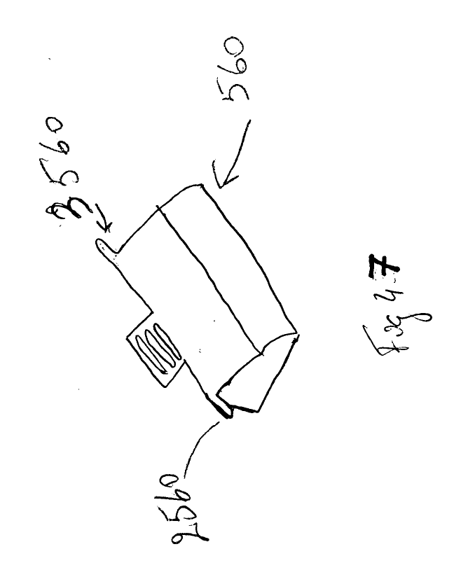

In another embodiment schematically represented in FIG. 48-51, the mop head 514 can comprise a slideable rod member 570 having a top, bottom, front and back surface and a first and second end and which can be located within the mop head 514. This slideable rod member 570 can be substantially longitudinal.

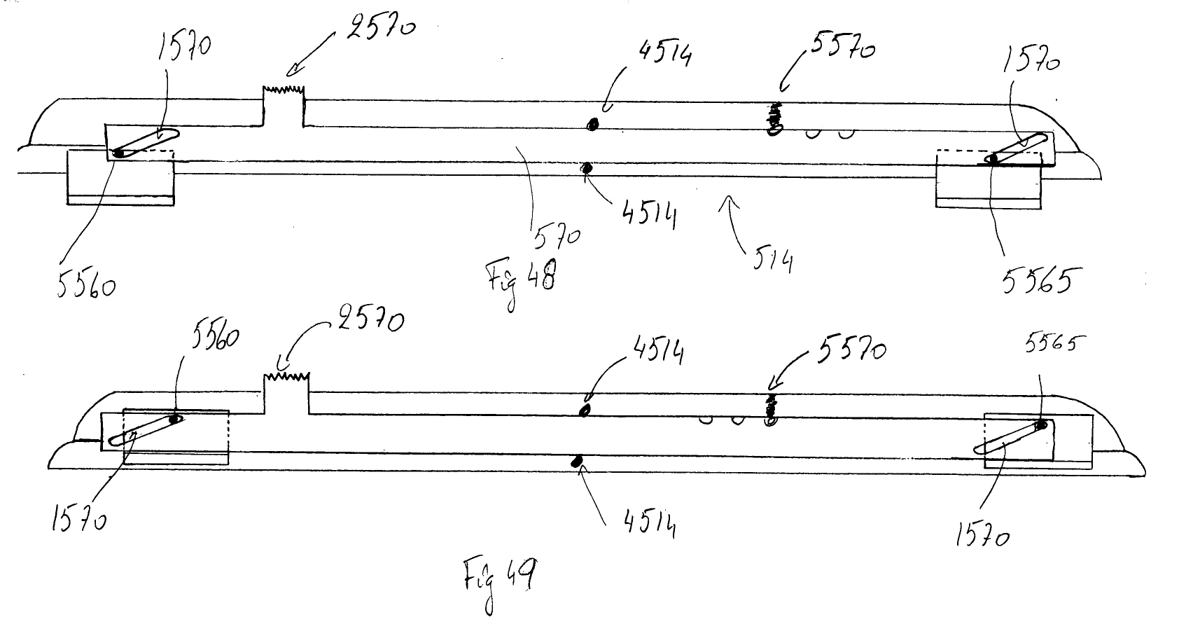

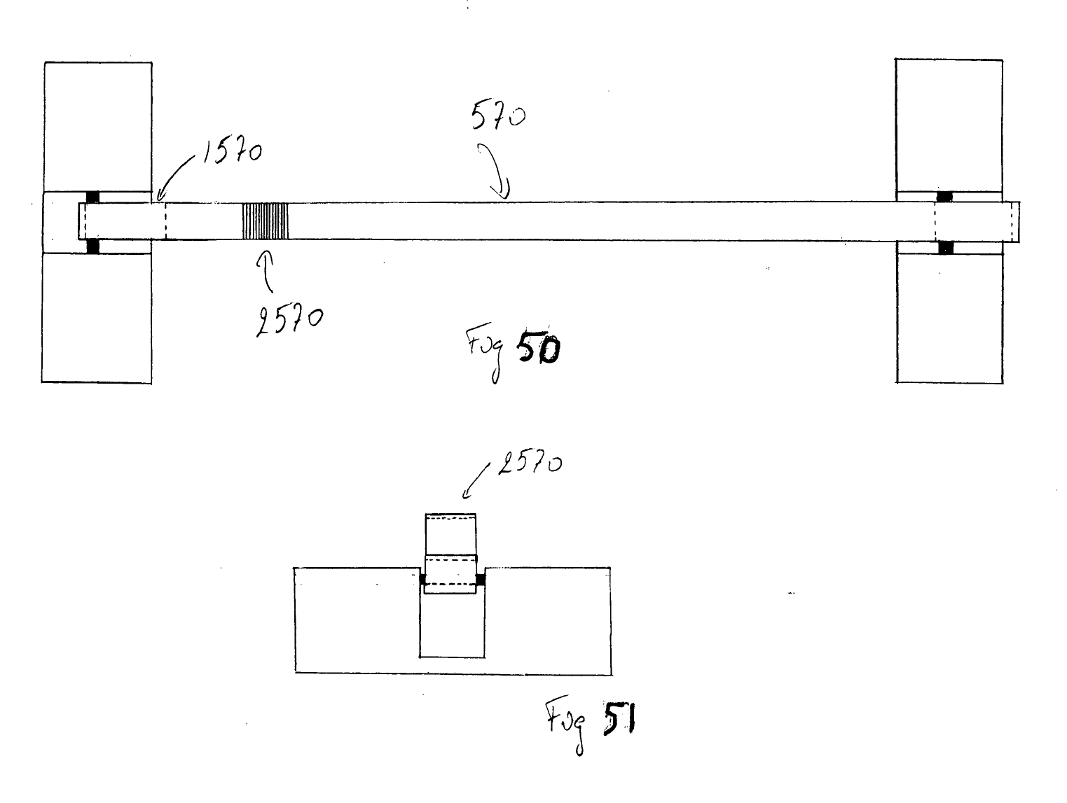

In one embodiment, the slideable rod member 570 comprises at least two grooves or guide members 1570. Each groove or guide member can be respectively located adjacent the first and second end of the slideable rod member 570. Preferably, each groove or guide member 1570 can be located on the front and/or back surface of the slideable rod member 570. The slideable rod member 570 can be slideably moved along the longitudinal axis of the mop head 514 via an arm member 2570 which can be attached to the top surface of the slideable rod member 570 and which extends through a slit or cut out preferably located on the top surface of the mop head 514. The mop head 514 comprises at least one but preferably two gliding members 560, 565 which can extend through corresponding cut outs made on the bottom surface of the mop head as represented in FIG. 48. In one embodiment, each gliding member has a substantially rectangular shape having top, bottom, right, left, front and bottom surfaces. Each gliding member also comprises at least one, but preferably two pin members 5560, 5565 for engaging the groove or guide member 1570 of the slideable rod member 570 as represented in FIGS. 50-51. The pin members can be attached to any of the sides of the gliding members 560, 565 but it can be preferred that the pin members be attached to the front and/or back side of the gliding members. In another embodiment, the gliding members have a substantially U shape as depicted in FIG. 51. In this embodiment, each gliding member comprises a bottom portion and a front and back portion defining an empty space in between. The pin member(s) can be attached to the gliding member(s) such that they extend towards this empty space. In this embodiment, the slideable rod member 570 can be located within this empty space such that the pin member(s) 5560 engages a corresponding groove 1570 of the slideable rod member 570. Each groove or guide member 1570 is preferably oriented diagonally relative to the front and/or back surface of the slideable rod member 570 such that a longitudinal motion of the slideable rod member 570 results in an upward or downward motion of the gliding members 560, 565. It might be preferred that the “slope” of the groove located adjacent the first end of the slideable rod member, be substantially equal to the slope of the groove located adjacent the second end of the slideable rod member. As previously discussed, one skilled in the art will understand that a motion of the slideable rod member 570 along the longitudinal axis of the mop head 514 will result in a motion of the gliding member 560 and 565 along the elevational axis of the mop head, i.e. upwards or downwards, as shown in FIGS. 48 and 49. One skill in the art will also understand that the pin members 5560 can be attached to the slideable rod member 570 and can engage a groove 1570 located on the gliding member 560 and still provide the same benefits. Optionally but preferably, the mop head can comprise a retaining member 4514 located within the mop head for preventing an upward or downward motion of the slideable rod member 570. As previously described, the gliding members 560 and 565 can be adjusted from a first position to a second position and vice versa. A user can simply push or pull the arm member 2570 in order to extend or retract the gliding members 560 and 565 depending on the kind of cleaning sheet she wishes to use. Optionally, the slideable rod member can comprise a locking mechanism comprising a spring-loaded mechanism 5570 which can be attached to the slideable rod member 570. This spring loaded mechanism is capable of releasably engaging one of a plurality of recesses located on the inner surface of the mop head along an axis which is substantially parallel to the slideable rod member 570. In one embodiment, the height of gliding members 560, 565 can be adjusted to as many “levels” as the number of recesses which are engageable by the spring-loaded mechanism 5570. In order to increase or decrease the height of the gliding members 560 and 565, a user can push or pull the arm member 2570 but also needs to overcome the axial force of the spring-loaded mechanism.

In another embodiment, the mop head 514 comprises at least one but preferably two, spring-loaded gliding members 560, 565. In one embodiment, each gliding member 560, 565, can be in contact with at least one but preferably two spring members, 3560 which tend to pull or push each gliding member inwardly. The slideable rod member 570 can comprise at least one, but preferably two, notches or cut out 6570 having a “biased” portion. In a preferred embodiment, the slope of the “biased” portion of the first notch is substantially equal to the slope of the “biased” portion of the second notch. When the slideable rod member 570 is moved longitudinally within the mop head 514, the “biased” portions of each notch come into contact with an edge of top surface of the gliding members 560, 565 and forces the gliding members to extend through the bottom surface of the mop head. When the slideable rod member 570 is moved to the opposite direction, the spring members 3560 pull or push each gliding member back within the mop head 514. As previously discussed, a longitudinal motion of the slideable rod member 570 will result in an elevational motion of the gliding members 560, 565 either in an upward or downward direction.

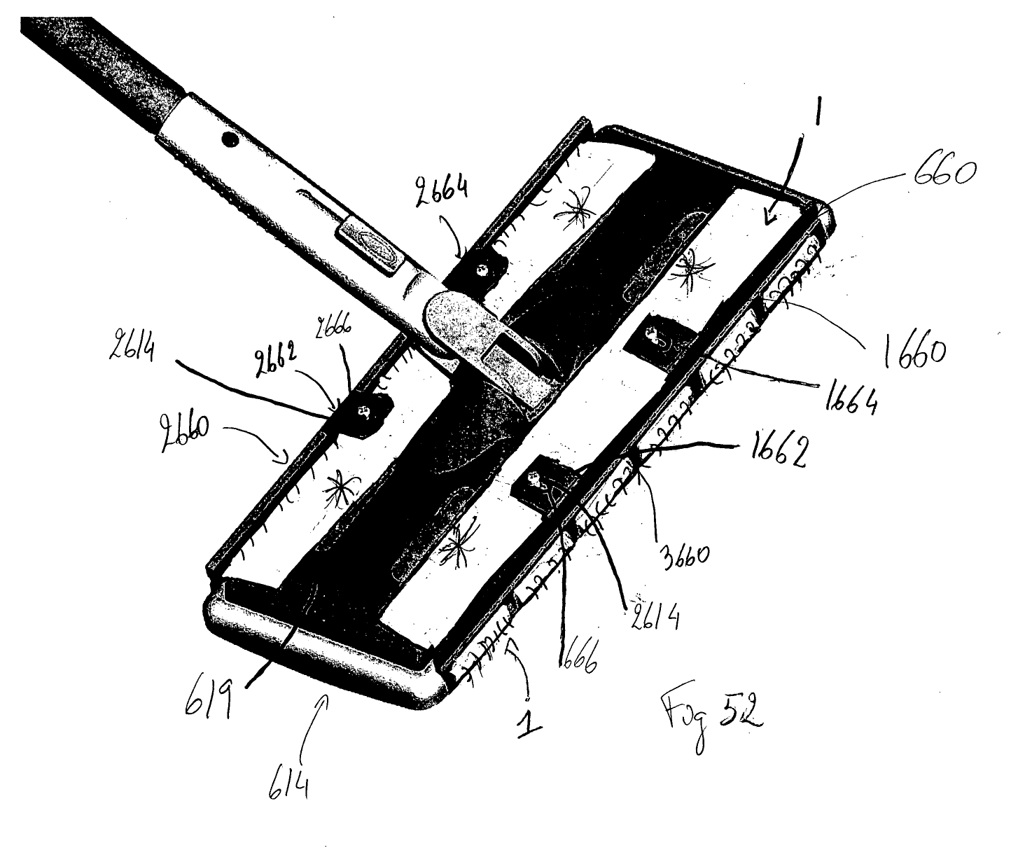

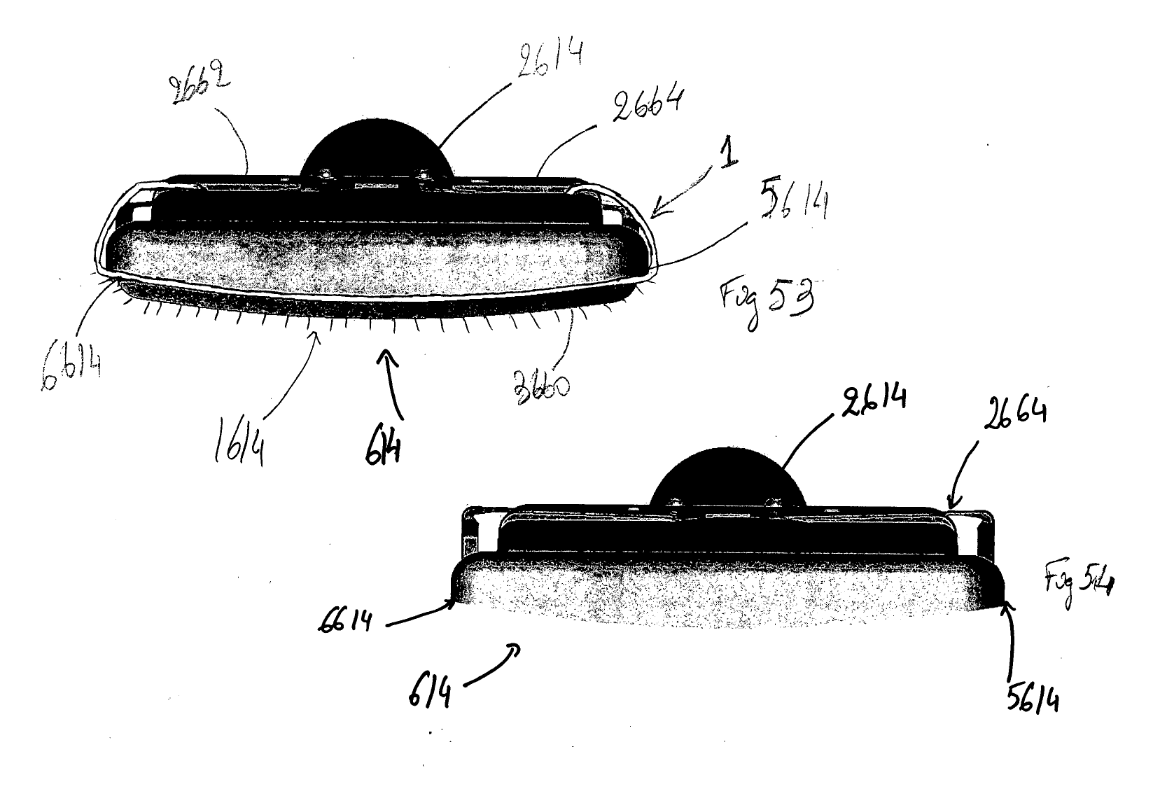

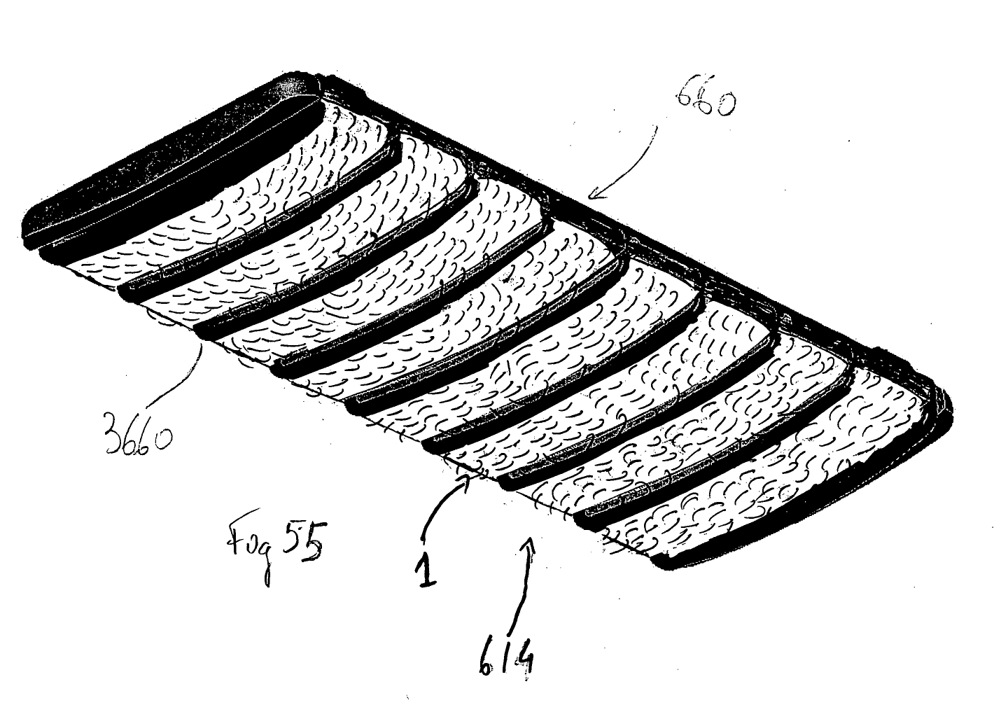

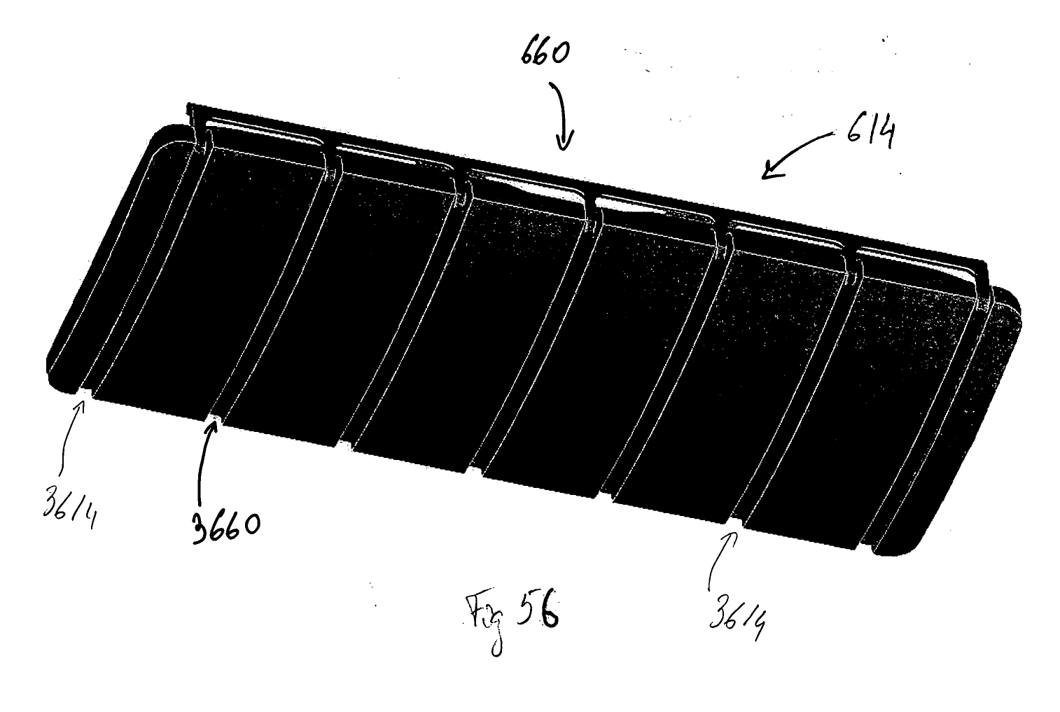

In another embodiment of the invention, represented in FIG. 52 through 56, the floor mop comprises a mop head 614 having a top and a bottom surface, a left and a right side, and a frame member 660 which can be removably attached to the mop head 614. The frame member 660 comprises at least one but preferably two longitudinal elements 1660 and 2660 which can be substantially parallel to each other. In a preferred embodiment, at least one but preferably both longitudinal elements 1660 and 2660 can be removably attached to the mop head 614. The frame member 660 also comprises at least one, preferably between 1 and 25, more preferably between 2 and 10, most preferably between 3 and 6 gliders 3660 attached the longitudinal element 1660 and/or 2660. In this embodiment, a user can use the cleaning implement having a mop head 614 with a dry cleaning sheet or an absorbent cleaning pad to clean a hard surface. The user can also attach a cleaning sheet comprising protrusions to the mop head and then attach the frame member 660 to the mop head such the portion of the sheet comprising the protrusions is located between the mop head 614 and the frame member 660. In this configuration, represented in FIG. 53 and 55, at least some of the gliders 3660 allow the cleaning implement to smoothly glide across the surface being cleaned. One skilled in the art will understand that the frame member 660 might be sufficient to retain the cleaning sheet having protrusions 1 on the mop head. As a result, the grippers 619 become optional but might still be preferred. Once a user has finished cleaning a soft surface, she can simply remove the frame member 660 from the mop head 614 and then remove the cleaning sheet comprising protrusions from the mop head. In one embodiment at least some of the gliders 3660 are substantially perpendicular to the longitudinal element 1660 and/or 2660. In another embodiment, at least some of the gliders are attached to the longitudinal element 1660 and/or 2660 such that the angle between some of the gliders 3660 and the longitudinal element 1660 and/or 2660 is comprised between about 0 degrees and about 90 degrees, preferably between about 45 degrees and about 90 degrees and most preferably between about 70 and about 85 degrees. The glider(s) can have a width 3661 comprised between about 0.5 mm and 40 mm, preferably between about 1 mm and 30 mm, more preferably between about 2 mm and about 20 mm and even most preferably between about 5 mm to about 15 mm. The glider(s) can have any suitable geometric shape. Non-limiting examples of geometric shapes include rectangular, triangular, trapezoid, hyperbolic, parabolic, sinusoidal and any combinations thereof. In another embodiment, it might be preferred that the width of each glider vary along the length of the glider. In yet another embodiment, it might be preferred that the height of each glider vary along the length of the glider. In another embodiment, it might also be preferred that the width of each glider vary along the height of the glider. In one embodiment, the width of the portion of the glider(s) which is in contact with the soft surface can be greater than the width of the portion of the glider which is in contact with the cleaning sheet. Without intending to be bound by any theory, it is believed that such tapered glider(s) improve the cleaning efficiency of a cleaning sheet having protrusions by fitting in between the protrusions of the sheet. Without intending to be bound by any theory, it is believed that a good “glide” of the mop head with a cleaning sheet having protrusions on a soft surface, is related to both the “height” of the glider(s) as well as the gliding ratio between the total surface area of the glider(s) to the total surface of the bottom surface of the mop head. For example, a cleaning sheet with protrusions on a mop head 614 which is used without a frame member. 660, would have a gliding ratio of zero. On the other hand, a cleaning sheet with protrusions attached to a mop head 614 that is used with a frame member 660 covering entirely the cleaning sheet (i.e. perfect glide of the mop head on the soft surface) would have a gliding ratio of 1. In one embodiment, the width of the glider(s) is such that the gliding ratio is comprised between about 0.01 and about 0.35, preferably between about 0.05 and about 0.25, most preferably between about 0.1 and about 0.15. In another embodiment of the invention, at least some of the gliders 3660 can have a different width. When the frame member 660 comprises 2 gliders 3660, each glider 3660 can be attached to each ends of the longitudinal element 1660 and/or 2660. When the frame member 660 comprises at least three gliders 3660, it might be preferred that each glider 3660 be attached to the longitudinal member 1660 and/or 2660 such that the distance between two consecutive gliders is identical to the distance between two other consecutive gliders 3660. In another embodiment, the distance between a series of consecutive gliders 3660 can be increasing or decreasing and still provide the same benefits. In one embodiment of the invention, a mop head 614 can have a “crown” bottom surface 1614. It might be desirable to provide a curved profile having a substantially continuous radius of curvature, as shown in FIG. 53-54, such that a more pure circular arc is achieved. The radius of curvature can be determined for a substantially curved bottom surface by measuring the radius of a circle passing through the terminuses 5614 and 6614 of the bottom surface of the mop head and the tangency point of the contact surface of the bottom surface. The radius of curvature is preferably at least about 200 mm, and, more preferably, is at least about 1000 mm. Most preferably, the radius of curvature is between about 200 mm and about 1200 mm. This “crown” bottom surface can have a fixed radius of curvature or a variable radius of curvature. In one embodiment, it can be preferred that the glider(s) 3660 of the frame member 660 have the same concavity and radius of curvature than the “crown” bottom surface 1614 of the mop head 614. In another embodiment, it might be preferred that the radius of curvature of the glider(s) 3660, be different than the angle of curvature of the “crown” bottom surface 1614 of the mop head 614. In one embodiment, the radius of curvature of the glider(s) 3660 is smaller than the radius of curvature of the “crown” bottom surface 1614 of the mop head 614. Without intending to be bound by any theory, it is believed that when the bottom surface of a mop head 614 is substantially flat, it might be beneficial to use this mop head with a frame member 660 comprising convex glider(s). In this embodiment, the convex glider(s) not only enhance the glide of the mop head on a soft surface, but in addition provide a “rocking” motion to the mop head which increases the “use efficiency” of a cleaning sheet with protrusions. As previously discussed, the frame member can be removably attached to the mop head 614. In one embodiment, the frame member 660 is clipable to the mop head 614. This can be simply done by having at least one clip or rib on at least one of the longitudinal members 1660 and/or 2660. In another embodiment, the frame member 660 can be hingedly attached to the leading or trailing edge on the mop head 614 and can be clipable respectively to the trailing or leading edge. In another embodiment, a strip of hooks and loops fasteners such as Velcro® material can be attached to the longitudinal member 1660 and/or 2660 in order to allow a user to attach the frame member 660 to the mop head 614. In one embodiment of the invention, the frame member 660 comprises at least one but preferably two strip of elastic material attached to both the longitudinal member 1660 and 2660. In another embodiment of the invention represented in FIG. 52, The frame member 660 can comprise at least one, preferably two, more preferably four strips of a substantially flexible material 1662, 1664, 2662 and 2664 attached to the longitudinal member 1660 and/or 2660. These strips of flexible material 1662, 1664, 2662 and 2664 comprise at least one recess or projection 1666 and 2666 for being engaged or engaging a corresponding projection or recess 2614 on the top surface of the mop head 614. In a preferred embodiment of the invention, the strips of flexible material 1662, 1664, 2662 and 2664 comprise a plurality of recesses 1666 and 2666 and the mop head 614 comprises four projections 2614 which are 30 preferably symmetrically located on the top surface of the mop head 614. One skilled in the art will understand that the projections 2614 can be in a different location, for example on the sides of the mop head 614, and still provide the same benefits. Among other benefits, this embodiment allows the user to clean a hard or soft surface when the frame member 660 is removed from the mop head 614 with a dry cleaning sheet or absorbent cleaning pad. This embodiment also allows the user to clean a soft surface with a cleaning sheet comprising protrusions and a frame member 660 but also set the height of the glider(s) 3660 relative to the bottom surface of the mop head 614 depending on the kind of cleaning sheet which is used and/or soft surface to be cleaned. One skilled in the art will understand that depending on which recess 1666, 2666 is engaged by the projection(s) 2614, the height of the glider(s) 3660 will adjusted. In an even preferred embodiment, the bottom surface of the mop head 614 comprises at least one but preferably a plurality of grooves 3614 as represented in FIG. 55. Each groove 3614 can be “facing” at least one corresponding glider 3660. The depth and the width of the grooves 3614 are such that a groove 3614 can enclose at least partially, but preferably entirely, at least one corresponding glider 3660. When the glider(s) 3660 are at least partially but preferably entirely located within a groove 3614, a user can use the cleaning implement with a dry cleaning sheet or absorbent pad without having to remove the frame member 660 entirely as represented in FIG. 54. Among other benefits, this embodiment allows a user to keep the frame member 660 attached to the mop head even when the glider(s) 3660 are not required. As a result, the frame member 660 is less likely to be lost or misplaced by a user. One skilled in the art will appreciate that other types of adjustable attachment mechanism for adjusting the height of the gliders 3660 can be used and provide the same benefits. Non-limiting examples of adjustable attachment mechanism can be hook and loop fasteners such as a strip of hook and loops fasterner such as Velcro® material attached to the longitudinal members 1660 and/or 2660, strips of material attached at one end to the longitudinal members and having a hook member at the other end for engaging at least one notch or recess on the mop head 614 or strips of material comprising a pressure sensitive adhesive.

It is noted that other configurations of gliders are encompassed by the present invention so as to facilitate the ability of the cleaning implement to glider across the surface being cleaned.

C. Other Optional Features

The present cleaning implements can also incorporate other optional, but preferred features, including, but not limited to: (a) a mop head having a curved bottom surface; and/or (b) a conformable mop pad affixed to the bottom surface of the mop head.

An optional, but preferred, feature of the cleaning implements herein includes a mop head having a curved bottom surface. A curved bottom surface of the mop head helps to facilitate the cleaning sheet to remove debris from the surface being cleaned. FIG. 3 shows a slightly curved bottom surface of the mop head 14.

Preferred curved mop heads are described in detail in co-pending U.S. application Ser. No. 09/821,953 filed Mar. 30, 2001 by Kacher et-al.

The bottom surface of the mop head of the present cleaning implement also preferably comprises a mop pad affixed thereto. The mop pad is preferably made of a relatively soft, conformable material. This will further facilitate the ability of the cleaning sheet to remove debris from the surface being cleaned. Suitable materials for making the mop pad include, for example, PVC, polyurethane, polyethylene, EVA, and the like.

FIGS. 4 and 5 show a mop pad 60 affixed to the bottom surface of the mop head 43 of the cleaning implement 41. If the cleaning implement comprises a pair of gliders 57, as in FIGS. 4 and 5, the mop pad 60 is preferably positioned in between the pair of gliders 57.

The mop head of the present cleaning implement can optionally further comprise a bumper. A bumper generally surrounds the outside edges of the mop head. The bumper is typically made of a relatively soft material which helps to prevent damage to furniture and other potential items in the path of the cleaning implement when a surface is being cleaned. A suitable material for making a bumper is santaprene.

FIGS. 4 and 5 show a mop head 43 comprising a bumper 61 which surrounds the outside edges of the mop head 43.

The present cleaning implements can further comprise attachments for attaching a removable cleaning sheet to the cleaning implement. “Grippers” are preferred way to attach the present cleaning sheets to a cleaning implement, as shown in FIG. 8. Preferred grippers are described in detail in co-pending U.S. application Ser. No. 09/374,714 filed Aug. 13, 1999 by Kingry et al. Another way to attach the present cleaning sheets to a cleaning implement is via a hook-and-loop fastener system. If a hook-and-loop fastener system is used, the substrate of the cleaning sheet will have either hooks or loop material affixed to the surface of the substrate in contact with the mop head of the cleaning implement, which will have complementary loop or hook material affixed thereto to engage the hook or loop material of the cleaning sheet.

The cleaning implement 11 of FIG. 1 has four grippers 19 which are located near each of the four corners of the mop head 14. The grippers 19 are capable of engaging the corners of a removable cleaning sheet attached to the cleaning implement 11.

III. Methods of Use

The present invention further relates to a method of using the cleaning implements herein. The present methods for removing debris from a surface generally comprise the step of contacting the surface with a cleaning implement according to the present invention. A removable cleaning sheet is preferably attached to the cleaning implement.

The present cleaning implements can be used to clean a variety of surfaces. The surface cleaned with the present cleaning implements is preferably a fibrous surface, comprising filaments, threads, or mixtures thereof. The filaments or threads can be made of wool, silk, cotton, nylon, polypropylene, polyester, or mixtures thereof A preferred surface herein is carpet, including woven, cut-and-loop pile, plush, saxony, loop, berber, oriental, braided, sculptured, textured, shag, and combinations thereof.

When the surface being cleaned is carpet, the present methods can comprise the steps of vacuuming the carpet and then contacting the carpet with a cleaning implement of the present invention. The present cleaning implements are particularly effective in removing debris that is typically difficult to remove with conventional vacuum cleaners, such as pet hair.

The present methods can also encompass removing allergens from a surface, or reducing allergens in the air, comprising the step of contacting the surface with a cleaning implement of the present invention.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of limitation and the scope of the invention is defined by the appended claims which should be construed as broadly as the prior art will permit.

What is claimed is:

1. A locking device for locking the handle of a floor mop at a fixed angle, said floor mop comprising a mop head rotationally attached to a handle with a universal joint having a substantially cross shape, said locking device comprising:
a support plate;
a first locking plate attached to said support plate; and
a second and a third locking plate attached to said support plate.

2. The locking device of claim 1 wherein said first locking plate is attached to said support plate such that the angle between said first locking plate and said support plate is comprised between about 20 and 70 degrees.

3. The locking device of claim 2 wherein said second and said third locking plates are attached to said support plate such that the angle between said second and third locking plate and said support plate is comprised between about 20 and about 160 degrees.

4. The locking device of claim 1 wherein said first locking plate prevents rotation of said handle about a first rotational axis of said universal joint when said locking device is inserted within said universal joint.

5. The locking device of claim 1 wherein said second and third locking plate prevent rotation of said handle about a second rotational axis of said universal joint when said locking device is inserted within said universal joint.

6. A locking device for locking the handle of a floor mop at a fixed angle, said floor mop comprising a mop head rotationally attached to a handle with a universal joint having a first and a second rotational axis, wherein said first and second rotational axis are located in different planes, said locking device comprising:
a support plate, said support plate comprising a notch substantially adjacent one of said support plate edges;
a first locking plate having a top and a bottom portion wherein said first locking plate is attached to said support plate; and
a second and a third locking plate having a top and a bottom portion, wherein said second and third locking plates are attached to said support plate such that said notch is located substantially between said second and third locking plates.

7. The locking device of claim 6 wherein the length of said second and third locking plates is greater than the length of said first locking plate such that when said bottom portion of said first, second and third locking plates are in contact with a substantially flat surface, the handle between said first, second and third plates and said substantially flat surface is comprised between about about 20 and about 160 degrees.

8. The locking device of claim 7 wherein said first, second and third locking plates prevent rotation of said handle about said first rotational axis of said universal joint when said universal joint is located within said locking device.

9. The locking device of claim 7 wherein said first, support plate prevents rotation of said handle about said second rotational axis of said universal joint when said universal joint is located within said locking device.
